(19) United States
(12) Patent Application Publication
(10) Pub. No.: US 2026/0266759 A1
(43) Pub. Date: Sep. 10, 2026

(54) GAS SENSOR AND CONTROL METHOD OF GAS SENSOR

(71) Applicant: NGK INSULATORS, LTD., Nagoya-shi (JP)

(72) Inventors: Shingo TANAKA, Kasugai-shi (JP); Atsuhiko MASUDA, Nagoya-shi (JP)

(21) Appl. No.: 19/550,387

(22) Filed: Feb. 26, 2026

(30) Foreign Application Priority Data
Mar. 5, 2025 (JP) 2025-035040

(51) Int. Cl. G01N 27/41; G01M 15/10; G01N 27/406

(52) U.S. Cl. CPC G01N 27/41; G01M 15/102; G01N 27/4065

(57) ABSTRACT

A gas sensor includes a sensor element and a control unit. The sensor element includes an oxygen pump cell, a first measurement pump cell, a second measurement pump cell. A concentration calculating part of the control unit calculates a carbon dioxide concentration and a water vapor concentration in the measurement-object gas by considering an oxygen pump current flowing through the oxygen pump cell as a function of the carbon dioxide concentration, the water vapor concentration and an oxygen concentration in the measurement-object gas, considering a first measurement pump current flowing through the first measurement pump cell as a function of the water vapor concentration, and the carbon dioxide concentration and/or the oxygen concentration, and considering a second measurement pump current flowing through the second measurement pump cell as a function of the carbon dioxide concentration, and the water vapor concentration and/or the oxygen concentration.

### CROSS-REFERENCE TO RELATED APPLICATION

The present application claims priority from Japanese Patent Application No. 2025-035040, filed on Mar. 5, 2025, the content of which is hereby incorporated by reference into this application.

### BACKGROUND OF THE INVENTION

### Technical Field of the Invention

The present invention relates to a gas sensor for detecting a target gas to be measured in a measurement-object gas.

### Background Art

Measurement of concentration of an objective gas component (oxygen O₂, water vapor H₂O, carbon dioxide CO₂, nitrogen oxide NOx, ammonia NH₃, hydrocarbon HC, etc.) in a measurement-object gas is required in various fields, for example, in combustion control and exhaust gas control of an internal combustion engine such as an engine of automobile, in environment control, in a medical field, a biotechnology field, and an agriculture and industry field. Various measurement devices are used for the concentration measurement, and as an example, a limiting current-type gas sensor using an oxygen ion conductive solid electrolyte such as zirconia (ZrO₂) is known.

For example, JP 5918177 B2 discloses a gas sensor that identifies concentrations of a water vapor component and a carbon dioxide component of a measurement gas based on a current flowing through a solid electrolyte. For example, WO 2024/202731 A1 and WO 2024/202763 A1 disclose a gas sensor that has three pump cells. WO 2024/202731 A1 and WO 2024/202763 A1 disclose that in the gas sensor, a first pump cell is controlled to reduce water and carbon dioxide in a measurement gas, a second pump cell is controlled to oxidize hydrogen generated by reduction of the water, and a third pump cell is controlled to oxidize carbon monoxide generated by reduction of the carbon dioxide.

### CITATION LIST

### Patent Documents

Patent Document 1: JP 5918177 B2

Patent Document 2: WO 2024/202731 A1

Patent Document 3: WO 2024/202763 A1

### SUMMARY OF THE INVENTION

### Problems to Be Solved by the Invention

A plurality of gas species generally coexists in a measurement-object gas. Specifically, an exhaust gas from an internal combustion engine such as an engine of automobile contains a plurality of components such as oxygen, water vapor, carbon dioxide, hydrocarbon gas, and noninflammable gas, and a component ratio of the components and a gas temperature may momently change. Accordingly, the measurement-object gas is generally a gas containing a plurality of gas species.

The gas sensor is required to accurately measure a concentration of a target gas to be measured regardless of gas composition in a measurement-object gas. For example, WO 2024/202731 A1 discloses a gas sensor that determines a carbon dioxide concentration by taking a second pump current flowing through the second pump cell into account in a third pump current flowing through the third pump cell. Further, for example, WO 2024/202763 A1 discloses a gas sensor that determines a water concentration by taking the third pump current flowing through the third pump cell into account in the second pump current flowing through the second pump cell.

When multiple gasses in a measurement-object gas are target gases to be measured, a gas sensor is required to accurately measure each concentration of the multiple target gases to be measured in the measurement-object gas regardless of gas composition in the measurement-object gas.

It is therefore an object of the present invention to provide a gas sensor that can accurately measure each concentration of multiple target gases to be measured including carbon dioxide and water vapor in a measurement-object gas regardless of gas composition in the measurement-object gas.

### Means for Solving the Problems

As a result of intensive studies, the present inventors have found that, by using numerical analysis, it is possible to accurately measure carbon dioxide and water vapor in the measurement-object gas regardless of the gas composition in the measurement-object gas. The present invention includes the following aspects.

(1) A gas sensor for detecting carbon dioxide and water vapor in a measurement-object gas, the gas sensor comprising a sensor element and a control unit for controlling the sensor element, wherein
the sensor element comprises:
a base part in an elongated plate shape, including an oxygen-ion-conductive solid electrolyte layer;
a measurement-object gas flow cavity having a gas inlet that opens on a surface of the base part, a first internal cavity that communicates with the gas inlet via a first diffusion-rate limiting path, and a second internal cavity that communicates with the first internal cavity via a second diffusion-rate limiting path;
an oxygen pump cell including an intracavity oxygen pump electrode disposed in the first internal cavity of the measurement-object gas flow cavity, and an extracavity oxygen pump electrode disposed at a position different from the measurement-object gas flow cavity on the base part and corresponding to the intracavity oxygen pump electrode;
a first measurement pump cell including an intracavity first measurement electrode disposed in the second internal cavity of the measurement-object gas flow cavity, and an extracavity first measurement electrode disposed at a position different from the measurement-object gas flow cavity on the base part and corresponding to the intracavity first measurement electrode; and
a second measurement pump cell including: an intracavity second measurement electrode disposed at a position opposite to the second diffusion-rate limiting path with respect to the intracavity first measurement electrode in the second internal cavity, or in a third internal cavity that communicates with the second internal cavity via a third diffusion-rate limiting path of the measurement-object gas flow cavity; and an extracavity second measurement electrode disposed at a position different from the measurement-object gas flow cavity on the base part and corresponding to the intracavity second measurement electrode;
the control unit comprises:
   a pump control part for controlling operation of the oxygen pump cell, the first measurement pump cell and the second measurement pump cell, and
   a concentration calculating part for calculating a concentration of each of carbon dioxide and water vapor in a measurement-object gas, wherein
the pump control part applies a predetermined oxygen pump voltage between the intracavity oxygen pump electrode and the extracavity oxygen pump electrode of the oxygen pump cell to pump out oxygen from the first internal cavity and decompose the water vapor and the carbon dioxide in the measurement-object gas in the first internal cavity,
the pump control part applies a predetermined first measurement pump voltage between the intracavity first measurement electrode and the extracavity first measurement electrode of the first measurement pump cell to pump oxygen into the second internal cavity and selectively oxidize, in the second internal cavity, hydrogen generated by decomposition of the water vapor, and
the pump control part applies a predetermined second measurement pump voltage between the intracavity second measurement electrode and the extracavity second measurement electrode of the second measurement pump cell to pump oxygen into near a surface of the intracavity second measurement electrode and selectively oxidize, near the surface of the intracavity second measurement electrode, carbon monoxide generated by decomposition of the carbon dioxide; and
the concentration calculating part calculates a carbon dioxide concentration and a water vapor concentration in the measurement-object gas by:
   considering an oxygen pump current flowing through the oxygen pump cell as a function of the carbon dioxide concentration, the water vapor concentration and an oxygen concentration in the measurement-object gas,
   considering a first measurement pump current flowing through the first measurement pump cell as a function of the water vapor concentration in the measurement-object gas, and the carbon dioxide concentration and/or the oxygen concentration in the measurement-object gas, and
   considering a second measurement pump current flowing through the second measurement pump cell as a function of the carbon dioxide concentration in the measurement-object gas, and the water vapor concentration and/or the oxygen concentration in the measurement-object gas.

(2) The gas sensor according to the above (1), wherein
the concentration calculating part previously stores:
   a conversion formula for the oxygen pump current expressing the oxygen pump current as the function of the carbon dioxide concentration, the water vapor concentration and the oxygen concentration in the measurement-object gas,
   a conversion formula for the first measurement pump current expressing the first measurement pump current as the function of the water vapor concentration in the measurement-object gas, and the carbon dioxide concentration and/or the oxygen concentration in the measurement-object gas, and
   a conversion formula for the second measurement pump current expressing the second measurement pump current as the function of the carbon dioxide concentration in the measurement-object gas, and the water vapor concentration and/or the oxygen concentration in the measurement-object gas; and
the concentration calculating part substitutes a value of the oxygen pump current flowing through the oxygen pump cell into the conversion formula for the oxygen pump current, substitutes a value of the first measurement pump current flowing through the first measurement pump cell into the conversion formula for the first measurement pump current, and substitutes a value of the second measurement pump current flowing through the second measurement pump cell into the conversion formula for the second measurement pump current, and
the concentration calculating part executes numerical analysis of the substituted conversion formula for the oxygen pump current, conversion formula for the first measurement pump current, and conversion formula for the second measurement pump current to calculate the carbon dioxide concentration and the water vapor concentration.

(3) The gas sensor according to the above (2), wherein the numerical analysis is executed by using a method selected from the group consisting of Newton method, a bisection method, Jacobi method, a secant method, and a stable method.

(4) The gas sensor according to the above (2) or (3), wherein the conversion formula for the second measurement pump current is a formula in which a term regarding the carbon dioxide concentration is multiplied by a term regarding the water vapor concentration and/or a term regarding the oxygen concentration.

(5) The gas sensor according to any one of the above (2) to (4), wherein the conversion formula for the first measurement pump current is a formula in which a term regarding the water vapor concentration is added to a term regarding the carbon dioxide concentration, and/or multiplied by a term regarding the oxygen concentration.

(6) The gas sensor according to any one of the above (2) to (5), wherein the conversion formula for the oxygen pump current is a formula in which a term regarding the carbon dioxide concentration, a term regarding the water vapor concentration and a term regarding the oxygen concentration are added together.

(7) The gas sensor according to the above (6), wherein the conversion formula for the oxygen pump current is a formula in which the term regarding the carbon dioxide concentration, and the term regarding the water vapor concentration are multiplied by a second term regarding the oxygen concentration.

(8) The gas sensor according to any one of the above (1) to (7), wherein the concentration calculating part calculates further the oxygen concentration in the measurement-object gas, in addition to the carbon dioxide concentration and the water vapor concentration in the measurement-object gas.

(9) The gas sensor according to any one of the above (1) to (8), wherein
the sensor element further comprises:
   a reference gas chamber formed inside the base part, and being separated from the measurement-object gas flow cavity, and
   a reference electrode disposed in the reference gas chamber, and
the pump control part applies the predetermined oxygen pump voltage between the intracavity oxygen pump electrode and the extracavity oxygen pump electrode of the oxygen pump cell based on a voltage between the intracavity oxygen pump electrode and the reference electrode to pump out oxygen from the first internal cavity and decompose the water vapor and the carbon dioxide in the measurement-object gas in the first internal cavity,
the pump control part applies the predetermined first measurement pump voltage between the intracavity first measurement electrode and the extracavity first measurement electrode of the first measurement pump cell based on a voltage between the intracavity first measurement electrode and the reference electrode to pump oxygen into the second internal cavity and selectively oxidize, in the second internal cavity, the hydrogen generated by the decomposition of the water vapor, and
the pump control part applies the predetermined second measurement pump voltage between the intracavity second measurement electrode and the extracavity second measurement electrode of the second measurement pump cell based on a voltage between the intracavity second measurement electrode and the reference electrode to pump oxygen into near the surface of the intracavity second measurement electrode and selectively oxidize, near the surface of the intracavity second measurement electrode, the carbon monoxide generated by the decomposition of the carbon dioxide.

(10) A control method of a gas sensor for detecting carbon dioxide and water vapor in a measurement-object gas, the gas sensor being the gas sensor according to any one of the above (1) to (9), and
the control method comprising:
   a concentration calculation step of calculating a carbon dioxide concentration and a water vapor concentration in the measurement-object gas by:
   considering an oxygen pump current flowing through the oxygen pump cell as a function of the carbon dioxide concentration, the water vapor concentration and an oxygen concentration in the measurement-object gas,
   considering a first measurement pump current flowing through the first measurement pump cell as a function of the water vapor concentration in the measurement-object gas, and the carbon dioxide concentration and/or the oxygen concentration in the measurement-object gas,
   considering a second measurement pump current flowing through the second measurement pump cell as a function of the carbon dioxide concentration in the measurement-object gas, and the water vapor concentration and/or the oxygen concentration in the measurement-object gas.

### Advantageous Effect of the Invention

According to the present invention, it is possible to provide a gas sensor that can accurately measure each concentration of multiple target gases to be measured including carbon dioxide and water vapor in a measurement-object gas regardless of gas composition in the measurement-object gas.

### BRIEF DESCRIPTION OF THE DRAWINGS

FIG. 1 is a vertical sectional schematic view in a longitudinal direction of a sensor element 101, showing one example of a schematic configuration of a gas sensor 100.

FIG. 2 is a block diagram showing electric connections between a control unit 90 and respective pump cells 21, 50 and 41, and respective sensor cells 80, 81, 82, and 83 of the sensor element 101 in the gas sensor 100.

FIG. 3 is a graph showing one example of measurement results of CO₂ emissions in WLTC (Worldwide-harmonized Light vehicles Test Cycle) mode. The horizontal axis of the graph represents time [seconds; s], and the vertical axis of the graph represents accumulated CO₂ emissions [g].

FIGS. 4A to 4C include graphs showing one example of the preliminary measurement results for calculating a conversion formula (Ip2 conversion formula) for the second measurement pump current Ip2. FIG. 4A is a graph showing the second measurement pump current Ip2 when water vapor concentration (H₂O concentration) and oxygen concentration (O₂ concentration) are at constant and only carbon dioxide concentration (CO₂ concentration) is varied. The horizontal axis of the graph represents the CO₂ concentration [%], and the vertical axis of the graph represents the second measurement pump current Ip2 [μA]. FIG. 4B is a graph showing the second measurement pump current Ip2 when CO₂ concentration and O₂ concentration are at constant and only H₂O concentration is varied. The horizontal axis of the graph represents the H₂O concentration [%], and the vertical axis of the graph represents a relative value [%] of the second measurement pump current Ip2 when the second measurement pump current Ip2 at the H₂O concentration of 3% is set to 100%. FIG. 4C is a graph showing the second measurement pump current Ip2 when CO₂ concentration and H₂O concentration are at constant and only O₂ concentration is varied. The horizontal axis of the graph represents the O₂ concentration [%], and the vertical axis of the graph represents a relative value [%] of the second measurement pump current Ip2 when the second measurement pump current Ip2 at the O₂ concentration of 0% is set to 100%.

FIGS. 5A to 5C include graphs showing one example of the preliminary measurement results for calculating a conversion formula (Ip1 conversion formula) for the first measurement pump current Ip1. FIG. 5A is a graph showing the first measurement pump current Ip1 when H₂O concentration) and O₂ concentration are at constant and only CO₂ concentration is varied. The horizontal axis of the graph represents the CO₂ concentration [%], and the vertical axis of the graph represents the first measurement pump current Ip1 [μA]. FIG. 5B is a graph showing the first measurement pump current Ip1 when CO₂ concentration and O₂ concentration are at constant and only H₂O concentration is varied. The horizontal axis of the graph represents the H₂O concentration [%], and the vertical axis of the graph represents the first measurement pump current Ip1 [μA]. FIG. 5C is a graph showing the first measurement pump current Ip1 when CO₂ concentration and H₂O concentration are at constant and only O₂ concentration is varied. The horizontal axis of the graph represents the O₂ concentration [%], and the vertical axis of the graph represents a relative value [%] of the first measurement pump current Ip1 when the first measurement pump current Ip1 at the O₂ concentration of 0% is set to 100%.

FIGS. 6A to 6D include graphs showing one example of the preliminary measurement results for calculating a conversion formula (Ip0 conversion formula) for the main pump current Ip0. FIG. 6A is a graph showing the main pump current Ip0 when H₂O concentration and O₂ concentration are at constant and only CO₂ concentration is varied. The horizontal axis of the graph represents the CO₂ concentration [%], and the vertical axis of the graph represents the main pump current Ip0 [mA]. FIG. 6B is a graph showing the main pump current Ip0 when CO₂ concentration and O₂ concentration are at constant and only H₂O concentration is varied. The horizontal axis of the graph represents the H₂O concentration [%], and the vertical axis of the graph represents the main pump current Ip0 [mA]. FIG. 6C is a graph showing the main pump current Ip0 when CO₂ concentration and H₂O concentration are at constant (10% each) and only O₂ concentration is varied in the presence of CO₂ and H₂O. The horizontal axis of the graph represents the O₂ concentration [%], and the vertical axis of the graph represents a relative value [%] of the main pump current Ip0 when the main pump current Ip0 at the O₂ concentration of 0% is set to 100%. FIG. 6D is a graph showing the main pump current Ip0 when CO₂ concentration and H₂O concentration are at constant (0% each) and only O₂ concentration is varied in the absence of CO₂ and H₂O. The horizontal axis of the graph represents the O₂ concentration [%], and the vertical axis of the graph represents the main pump current Ip0 [mA].

FIG. 7 is a flow chart of concentration calculating processing of each of a carbon dioxide concentration, a water vapor concentration and an oxygen concentration in a measurement-object gas.

FIG. 8 is a flow chart of an example of the concentration calculating processing using Newton method.

FIG. 9 is a vertical sectional schematic view in the longitudinal direction of a sensor element 201, showing one example of a schematic configuration of a gas sensor 200 including the sensor element 201.

FIG. 10 is measurement results of accumulated CO₂ emissions in WLTC mode. The horizontal axis of the graph represents time [seconds; s], and the vertical axis of the graph represents the accumulated CO₂ emissions [g].

### MODES FOR CARRYING OUT OF THE INVENTION

A gas sensor of the present invention is a gas sensor that detects carbon dioxide and water vapor in a measurement-object gas, and includes a sensor element and a control unit for controlling the sensor element.

The sensor element contained in the gas sensor of the present invention includes:
a base part in an elongated plate shape, including an oxygen-ion-conductive solid electrolyte layer;
a measurement-object gas flow cavity having a gas inlet that opens on a surface of the base part, a first internal cavity that communicates with the gas inlet via a first diffusion-rate limiting path, and a second internal cavity that communicates with the first internal cavity via a second diffusion-rate limiting path;
an oxygen pump cell including an intracavity oxygen pump electrode disposed in the first internal cavity of the measurement-object gas flow cavity, and an extracavity oxygen pump electrode disposed at a position different from the measurement-object gas flow cavity on the base part and corresponding to the intracavity oxygen pump electrode;
a first measurement pump cell including an intracavity first measurement electrode disposed in the second internal cavity of the measurement-object gas flow cavity, and an extracavity first measurement electrode disposed at a position different from the measurement-object gas flow cavity on the base part and corresponding to the intracavity first measurement electrode; and
a second measurement pump cell including: an intracavity second measurement electrode disposed at a position opposite to the second diffusion-rate limiting path with respect to the intracavity first measurement electrode in the second internal cavity, or in a third internal cavity that communicates with the second internal cavity via a third diffusion-rate limiting path of the measurement-object gas flow cavity; and an extracavity second measurement electrode disposed at a position different from the measurement-object gas flow cavity on the base part and corresponding to the intracavity second measurement electrode. The sensor element may further include:
a reference gas chamber formed inside the base part, and being separated from the measurement-object gas flow cavity, and
a reference electrode disposed in the reference gas chamber.

The sensor element contained in the gas sensor of the present invention may be configured such that the measurement-object gas flow cavity has a gas inlet that opens on a surface of the base part, a first internal cavity that communicates with the gas inlet via a first diffusion-rate limiting path, a second internal cavity that communicates with the first internal cavity via a second diffusion-rate limiting path, and a third internal cavity that communicates with the second internal cavity via a third diffusion-rate limiting path; and
the second measurement pump cell includes an intracavity second measurement electrode disposed in the third internal cavity of the measurement-object gas flow cavity, and an extracavity second measurement electrode disposed at a position different from the measurement-object gas flow cavity on the base part and corresponding to the intracavity second measurement electrode.

The sensor element contained in the gas sensor of the present invention may be configured such that the measurement-object gas flow cavity has a gas inlet that opens on a surface of the base part, a first internal cavity that communicates with the gas inlet via a first diffusion-rate limiting path, and a second internal cavity that communicates with the first internal cavity via a second diffusion-rate limiting path; and
the second measurement pump cell includes an intracavity second measurement electrode disposed at a position opposite to the second diffusion-rate limiting path with respect to the intracavity first measurement electrode in the second internal cavity of the measurement-object gas flow cavity, and an extracavity second measurement electrode disposed at a position different from the measurement-object gas flow cavity on the base part and corresponding to the intracavity second measurement electrode.

The control unit contained in the gas sensor of the present invention includes:
a pump control part for controlling operation of the oxygen pump cell, the first measurement pump cell and the second measurement pump cell, and
a concentration calculating part for calculating a concentration of each of carbon dioxide and water vapor in a measurement-object gas, wherein
the pump control part applies a predetermined oxygen pump voltage between the intracavity oxygen pump electrode and the extracavity oxygen pump electrode of the oxygen pump cell to pump out oxygen from the first internal cavity and decompose the water vapor and the carbon dioxide in the measurement-object gas in the first internal cavity,
the pump control part applies a predetermined first measurement pump voltage between the intracavity first measurement electrode and the extracavity first measurement electrode of the first measurement pump cell to pump oxygen into the second internal cavity and selectively oxidize, in the second internal cavity, hydrogen generated by decomposition of the water vapor, and
the pump control part applies a predetermined second measurement pump voltage between the intracavity second measurement electrode and the extracavity second measurement electrode of the second measurement pump cell to pump oxygen into near a surface of the intracavity second measurement electrode and selectively oxidize, near the surface of the intracavity second measurement electrode, carbon monoxide generated by decomposition of the carbon dioxide; and
the concentration calculating part calculates a carbon dioxide concentration and a water vapor concentration in the measurement-object gas by:
   considering an oxygen pump current flowing through the oxygen pump cell as a function of the carbon dioxide concentration, the water vapor concentration and an oxygen concentration in the measurement-object gas,
   considering a first measurement pump current flowing through the first measurement pump cell as a function of the water vapor concentration in the measurement-object gas, and the carbon dioxide concentration and/or the oxygen concentration in the measurement-object gas, and
   considering a second measurement pump current flowing through the second measurement pump cell as a function of the carbon dioxide concentration in the measurement-object gas, and the water vapor concentration and/or the oxygen concentration in the measurement-object gas.

### Schematic Configuration of Gas Sensor

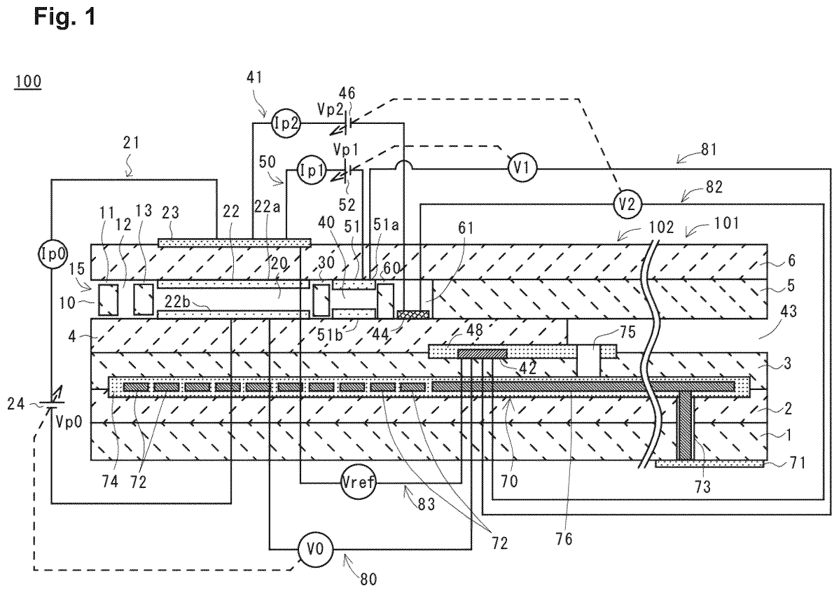

The gas sensor of the present invention will now be described with reference to the drawings. FIG. 1 is a vertical sectional schematic view in a longitudinal direction of a sensor element 101, showing one example of a schematic configuration of a gas sensor 100 including the sensor element 101. Hereinafter, based on FIG. 1, the upper side and the lower side in FIG. 1 are respectively defined as top and bottom, and the left side and the right side in FIG. 1 are respectively defined as a front end side and a rear end side.

In the embodiment of FIG. 1, the gas sensor 100 represents one example of a limiting current-type gas sensor that detects water vapor and carbon dioxide in a measurement-object gas by the sensor element 101, and measures the concentrations of the water vapor and the carbon dioxide.

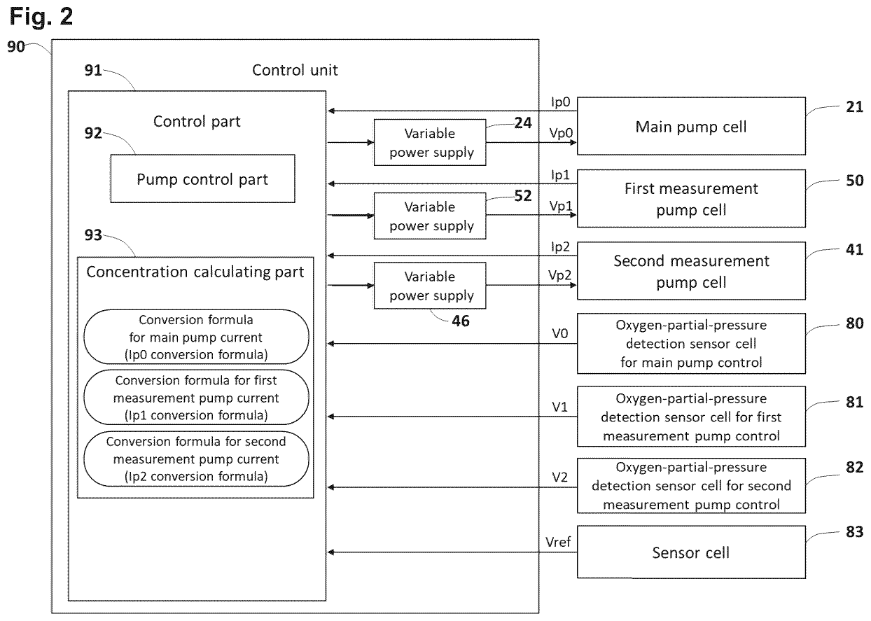

Further, the gas sensor 100 includes a control unit 90 for controlling the sensor element 101. FIG. 2 is a block diagram showing electric connections between the control unit 90 and the sensor element 101.

### (Sensor Element)

The sensor element 101 is an element in an elongated plate shape, including a base part 102 having such a structure that a plurality of oxygen-ion-conductive solid electrolyte layers are layered. The elongated plate shape also called a long plate shape or a belt shape. The base part 102 has such a structure that six layers, namely, a first substrate layer 1, a second substrate layer 2, a third substrate layer 3, a first solid electrolyte layer 4, a spacer layer 5, and a second solid electrolyte layer 6, are layered in this order from the bottom side, as viewed in the drawing. Each of the six layers is formed of an oxygen-ion-conductive solid electrolyte layer containing, for example, zirconia (ZrO₂). The solid electrolyte forming these six layers is dense and gastight. These six layers all may have the same thickness, or the thickness may vary among the layers. The layers are adhered to each other with an adhesive layer of a solid electrolyte interposed therebetween, and the base part 102 includes the adhesive layer. While a layer configuration composed of the six layers is illustrated in FIG. 1, the layer configuration in the present invention is not limited to this, and any number of layers and any layer configuration are possible.

A measurement-object gas flow cavity 15 has a gas inlet 10 that opens on a surface of the base part 102, a first internal cavity 20 that communicates with the gas inlet 10 via a first diffusion-rate limiting path 11 (namely, a first diffusion-rate limiting part), and a second internal cavity 40 that communicates with the first internal cavity 20 via a second diffusion-rate limiting path 30 (namely, a second diffusion-rate limiting part). In this embodiment, the measurement-object gas flow cavity 15 further has a third internal cavity 61 that communicates with the second internal cavity 40 via a third diffusion-rate limiting path 60 (namely, a third diffusion-rate limiting part). That is, this embodiment is an example of a structure having three internal cavities, namely, the first internal cavity 20 that communicates with the gas inlet 10 via the first diffusion-rate limiting path 11, the second internal cavity 40 that communicates with the first internal cavity 20 via the second diffusion-rate limiting path 30, and the third internal cavity 61 that communicates with the second internal cavity 40 via the third diffusion-rate limiting path 60.

The gas inlet 10 is formed between the lower surface of the second solid electrolyte layer 6 and the upper surface of the first solid electrolyte layer 4 in one end part in the longitudinal direction (hereinafter, referred to as a front end part) of the sensor element 101. The measurement-object gas flow cavity 15, that is, a measurement-object gas flow part is formed in such a form that the first diffusion-rate limiting path 11, a buffer space 12, an auxiliary diffusion-rate limiting path 13 (namely, an auxiliary diffusion-rate limiting part), the first internal cavity 20, the second diffusion-rate limiting path 30, the second internal cavity 40, the third diffusion-rate limiting path 60, and the third internal cavity 61 communicate in this order in the longitudinal direction from the gas inlet 10.

The gas inlet 10, the buffer space 12, the first internal cavity 20, the second internal cavity 40, and the third internal cavity 61 constitute internal spaces of the sensor element 101. Each of the internal spaces is provided in such a manner that a portion of the spacer layer 5 is hollowed out, and the top of each of the internal spaces is defined by the lower surface of the second solid electrolyte layer 6, the bottom of each of the internal spaces is defined by the upper surface of the first solid electrolyte layer 4, and the lateral surface of each of the internal spaces is defined by the lateral surface of the spacer layer 5.

Each of the first diffusion-rate limiting path 11, the auxiliary diffusion-rate limiting path 13, and the second diffusion-rate limiting path 30 is provided as two laterally elongated slits (having the longitudinal direction of the openings in the direction perpendicular to the figure in FIG. 1). Each of the first diffusion-rate limiting path 11, the auxiliary diffusion-rate limiting path 13, and the second diffusion-rate limiting path 30 may be in such a form that a desired diffusion resistance is created, but the form is not limited to the slits.

The third diffusion-rate limiting path 60 is provided as a single laterally elongated slit (having the longitudinal direction of the opening in the direction perpendicular to the figure in FIG. 1) between the spacer layer 5 and the second solid electrolyte layer 6. The third diffusion-rate limiting path 60 may be in such a form that a desired diffusion resistance is created, but the form is not limited to the slit.

Also, at a position farther from the front end than the measurement-object gas flow cavity 15, a reference gas introduction space 43 is disposed between the upper surface of the third substrate layer 3 and the lower surface of the spacer layer 5 at a position where the reference gas introduction space 43 is laterally defined by the lateral surface of the first solid electrolyte layer 4. The reference gas introduction space 43 has an opening in the other end part (hereinafter, referred to as a rear end part) of the sensor element 101. As a reference gas for concentration measurement, for example, air is introduced into the reference gas introduction space 43.

An air introduction layer 48 is a layer formed of porous alumina, and is so configured that a reference gas is introduced into the air introduction layer 48 via the reference gas introduction space 43. The air introduction layer 48 is formed to cover a reference electrode 42. In this embodiment, the air introduction layer 48 and the reference gas introduction space 43 correspond to the reference gas chamber of the present invention.

The reference electrode 42 is an electrode disposed in the reference gas chamber. The reference electrode 42 is an electrode sandwiched between the upper surface of the third substrate layer 3 and the first solid electrolyte layer 4, and as described above, the air introduction layer 48 leading to the reference gas introduction space 43 is disposed around the reference electrode 42. That is, the reference electrode 42 is disposed to be in contact with a reference gas via the air introduction layer 48 which is a porous material, and the reference gas introduction space 43. As will be described later, the reference electrode 42 can be used to measure the oxygen concentration (oxygen partial pressure) in the first internal cavity 20, the second internal cavity 40, and the third internal cavity 61. The reference electrode 42 may be formed as a porous cermet electrode (e.g., a cermet electrode of Pt and ZrO₂) in a rectangular shape in a planar view.

In the measurement-object gas flow cavity 15, the gas inlet 10 is open to the external space, and the measurement-object gas is taken into the sensor element 101 from the external space through the gas inlet 10.

In the present embodiment, the measurement-object gas flow cavity 15 is in such a form that the measurement-object gas is introduced through the gas inlet 10 that is open on the front end surface of the sensor element 101, however, the present invention is not limited to this form. For example, the measurement-object gas flow cavity 15 need not have a recess of the gas inlet 10. In this case, the first diffusion-rate limiting path 11 serves both as a gas inlet and a first diffusion-rate limiting path.

For example, the measurement-object gas flow cavity 15 may have an opening that communicates with the buffer space 12 or a position near the buffer space 12 of the first internal cavity 20, on a lateral surface along the longitudinal direction of the base part 102. In this case, the measurement-object gas is introduced from the lateral surface along the longitudinal direction of the base part 102 through the opening.

Further, for example, the measurement-object gas flow cavity 15 may be so configured that the measurement-object gas is introduced through a porous body.

The first diffusion-rate limiting path 11 creates a predetermined diffusion resistance to the measurement-object gas taken through the gas inlet 10.

The buffer space 12 is provided to mitigate the influence of pressure fluctuation on the detected value when the pressure of the measurement-object gas fluctuates. The sensor element 101 may have a structure without the buffer space 12.

The auxiliary diffusion-rate limiting path 13 creates a predetermined diffusion resistance to the measurement-object gas introduced into the first internal cavity 20 from the buffer space 12. The auxiliary diffusion-rate limiting path 13 is provided in association with the buffer space 12 being provided.

When the buffer space 12 and the auxiliary diffusion-rate limiting path 13 are not provided, the first diffusion-rate limiting path 11 directly communicates with the first internal cavity 20.

The first internal cavity 20 is provided as a space for adjusting the oxygen partial pressure in the measurement-object gas introduced through the auxiliary diffusion-rate limiting path 13. The oxygen partial pressure is adjusted by operation of a main pump cell 21. That is, the main pump cell 21 functions as an oxygen pump cell of the present invention.

The main pump cell 21 is an electrochemical pump cell including the inner main pump electrode 22 as an intra-cavity oxygen pump electrode disposed in the first internal cavity 20 of the measurement-object gas flow cavity 15, and an outer pump electrode 23 as an extra-cavity oxygen pump electrode disposed at a position different from the measurement-object gas flow cavity 15 on the base part 102 (in FIG. 1, on an outer surface of the base part 102) and corresponding to the inner main pump electrode 22. The phrase “corresponding to the inner main pump electrode 22” means that the outer pump electrode 23 and the inner main pump electrode 22 are provided with the second solid electrolyte layer 6 being interposed therebetween.

That is, the main pump cell 21 is an electrochemical pump cell composed of the inner main pump electrode 22 having a ceiling electrode portion 22a disposed over substantially the entire surface of the lower surface of the second solid electrolyte layer 6 that faces the first internal cavity 20, the outer pump electrode 23 disposed on the upper surface of the second solid electrolyte layer 6 so as to be exposed to the external space, and the second solid electrolyte layer 6 sandwiched between the inner main pump electrode 22 and the outer pump electrode 23.

The inner main pump electrode 22 is formed to span the upper and lower solid electrolyte layers (the second solid electrolyte layer 6 and the first solid electrolyte layer 4) that define the first internal cavity 20 and the spacer layer 5 that defines the lateral wall. Specifically, the ceiling electrode portion 22a is formed on the lower surface of the second solid electrolyte layer 6 that defines the ceiling surface of the first internal cavity 20, and a bottom electrode portion 22b is formed on the upper surface of the first solid electrolyte layer 4 that defines the bottom surface of the first internal cavity 20. Also, lateral electrode portions (not shown) are formed on the lateral wall surfaces (inner surface) of the spacer layer 5 that form both lateral wall parts of the first internal cavity 20 so as to connect the ceiling electrode portion 22a and the bottom electrode portion 22b. Thus, the inner main pump electrode 22 is provided as a tunnel-like structure in the area where the lateral electrode portions are disposed.

The inner main pump electrode 22 and the outer pump electrode 23 are porous cermet electrodes (electrodes in a state that a metal component and a ceramic component are mixed) in a rectangular shape in a planar view. The inner main pump electrode 22 and the outer pump electrode 23 may contain a noble metal having catalytic activity (e.g., at least one of Pt, Rh, Ir, Ru, and Pd) as the metal component. The ceramic component to be used is not particularly limited, but is preferably an oxygen-ion-conductive solid electrolyte as in the case of the base part 102. For example, each of the inner main pump electrode 22 and the outer pump electrode 23 may be a porous cermet electrode made of Pt and ZrO₂.

In the main pump cell 21, a pump voltage (oxygen pump voltage) Vp0 is applied between the inner main pump electrode 22 and the outer pump electrode 23 by a variable power supply 24 to make a main pump current Ip0 flow between the inner main pump electrode 22 and the outer pump electrode 23 in either a positive or negative direction, and thus it is possible to pump out oxygen in the first internal cavity 20 to the external space or pump oxygen into the first internal cavity 20 from the external space.

The inner main pump electrode 22, the second solid electrolyte layer 6, the spacer layer 5, the first solid electrolyte layer 4, the third substrate layer 3, and the reference electrode 42 form an electrochemical sensor cell, namely, an oxygen-partial-pressure detection sensor cell 80 for main pump control. In the oxygen-partial-pressure detection sensor cell 80 for main pump control, an electromotive force (a voltage V0) is generated between the inner main pump electrode 22 and the reference electrode 42 due to a difference in oxygen concentration between an atmosphere in the first internal cavity 20 and a reference gas in the reference gas introduction space 43.

The oxygen concentration (oxygen partial pressure) in the first internal cavity 20 can be detected from the voltage V0 measured in the oxygen-partial-pressure detection sensor cell 80 for main pump control. In addition, the main pump current Ip0 is controlled by performing feedback control of the pump voltage Vp0 in the variable power supply 24 so that the voltage V0 is constant. Thus, the oxygen partial pressure in the first internal cavity 20 can be maintained at a predetermined value.

The second diffusion-rate limiting path 30 creates a predetermined diffusion resistance to the measurement-object gas whose oxygen concentration (oxygen partial pressure) has been controlled in the first internal cavity 20 by the operation of the main pump cell 21, and guides the measurement-object gas into the second internal cavity 40.

The second internal cavity 40 is provided as a space for performing processing related to measurement of a water vapor concentration in the measurement-object gas introduced through the second diffusion-rate limiting path 30. By operation of a first measurement pump cell 50, oxygen is supplied from the outside of the sensor element 101 to the second internal cavity 40.

The first measurement pump cell 50 is an electrochemical pump cell including a first measurement electrode 51 as an intracavity first measurement electrode disposed in the second internal cavity 40 of the measurement-object gas flow cavity 15, and an extracavity first measurement electrode disposed at a position different from the measurement-object gas flow cavity 15 on the base part 102 and corresponding to the first measurement electrode 51. In this embodiment, the outer pump electrode 23 disposed on the outer surface of the base part 102 functions also as the extracavity first measurement electrode. The phrase “corresponding to the first measurement electrode 51” means that the outer pump electrode 23 and the first measurement electrode 51 are provided with the second solid electrolyte layer 6 being interposed therebetween.

That is, the first measurement pump cell 50 is an electrochemical pump cell composed of the first measurement electrode 51 having a ceiling electrode portion 51a disposed on substantially the entire surface of the lower surface of the second solid electrolyte layer 6 facing with the second internal cavity 40, the outer pump electrode 23 (the outer electrode is not limited to the outer pump electrode 23, but may be any suitable electrode disposed at a position different from the measurement-object gas flow cavity 15, for example, outside the sensor element 101), and the second solid electrolyte layer 6.

The first measurement electrode 51 is disposed in the second internal cavity 40 in a tunnel-like structure similar to the inner main pump electrode 22 disposed in the first internal cavity 20. Specifically, in the tunnel-like structure, the ceiling electrode portion 51a is formed on the second solid electrolyte layer 6 that defines the ceiling surface of the second internal cavity 40, a bottom electrode portion 51b is formed on the first solid electrolyte layer 4 that defines the bottom surface of the second internal cavity 40, and lateral electrode portions (not shown) connecting the ceiling electrode portion 51a and the bottom electrode portion 51b are formed on the wall surfaces of the spacer layer 5 that define the lateral walls of the second internal cavity 40.

The first measurement electrode 51 is a porous cermet electrode in a rectangular shape in a planar view, as with the case of the inner main pump electrode 22 and the outer pump electrode 23. The first measurement electrode 51 may contain a noble metal having catalytic activity (e.g., at least one of Pt, Rh, Ir, Ru, and Pd) as the metal component. The ceramic component to be used is not particularly limited, but is preferably an oxygen-ion-conductive solid electrolyte as in the case of the base part 102. For example, the first measurement electrode 51 may be a porous cermet electrode made of Pt containing 0.1 wt. % to 30.0 wt. % of Au and ZrO₂.

In the first measurement pump cell 50, by applying a pump voltage (first measurement pump voltage) Vp1 between the first measurement electrode 51 and the outer pump electrode 23 by a variable power supply 52 to make a first measurement pump current (water vapor detecting current) Ip1 flow between the first measurement electrode 51 and the outer pump electrode 23, it is possible to pump oxygen into the second internal cavity 40. In FIG. 1, a direction of pumping oxygen into the second internal cavity 40 is illustrated as a negative direction.

The first measurement electrode 51, the reference electrode 42, the second solid electrolyte layer 6, the spacer layer 5, the first solid electrolyte layer 4, and the third substrate layer 3 form an electrochemical sensor cell, namely, an oxygen-partial-pressure detection sensor cell 81 for first measurement pump control. In the oxygen-partial-pressure detection sensor cell 81 for first measurement pump control, an electromotive force (a voltage V1) is generated between the first measurement electrode 51 and the reference electrode 42 due to a difference in oxygen concentration between an atmosphere in the second internal cavity 40 and a reference gas in the reference gas introduction space 43.

The oxygen concentration (oxygen partial pressure) in the second internal cavity 40 can be detected from the voltage V1 measured in the oxygen-partial-pressure detection sensor cell 81 for first measurement pump control. The pump voltage Vp1 in the variable power supply 52 is feedback controlled on the basis of the voltage V1 detected by the oxygen-partial-pressure detection sensor cell 81 for first measurement pump control.

The third diffusion-rate limiting path 60 creates a predetermined diffusion resistance to the measurement-object gas whose oxygen concentration (oxygen partial pressure) has been controlled in the second internal cavity 40 by the operation of the first measurement pump cell 50, and guides the measurement-object gas into the third internal cavity 61.

The third internal cavity 61 is provided as a space for performing processing related to measurement of a carbon dioxide concentration in the measurement-object gas introduced through the third diffusion-rate limiting path 60. By operation of a second measurement pump cell 41, oxygen is supplied from the outside of the sensor element 101 to the third internal cavity 61.

The second measurement pump cell 41 is an electrochemical pump cell including a second measurement electrode 44 as an intracavity second measurement electrode disposed in the third internal cavity 61 of the measurement-object gas flow cavity 15, and an extracavity second measurement electrode disposed at a position different from the measurement-object gas flow cavity 15 on the base part 102 and corresponding to the second measurement electrode 44. In this embodiment, the outer pump electrode 23 disposed on the outer surface of the base part 102 functions also as the extracavity second measurement electrode. The phrase “corresponding to the second measurement electrode 44” means that the outer pump electrode 23 and the second measurement electrode 44 are provided with the second solid electrolyte layer 6, the spacer layer 5, and the first solid electrolyte layer 4 being interposed therebetween.

That is, the second measurement pump cell 41 is an electrochemical pump cell composed of the second measurement electrode 44 disposed on an upper surface of the first solid electrolyte layer 4 facing with the third internal cavity 61, the outer pump electrode 23 (the outer electrode is not limited to the outer pump electrode 23, but may be any suitable electrode disposed at a position different from the measurement-object gas flow cavity 15, for example, outside the sensor element 101), the second solid electrolyte layer 6, the spacer layer 5, and the first solid electrolyte layer 4. The second measurement electrode 44 is disposed at a position opposite to the second diffusion-rate limiting path 30 with respect to the first measurement electrode 51, that is, at a position farther from the second diffusion-rate limiting path 30 than the first measurement electrode 51.

The second measurement electrode 44 is a porous cermet electrode in a rectangular shape in a planar view, as with the case of the inner main pump electrode 22 and the outer pump electrode 23. The second measurement electrode 44 may contain a noble metal having catalytic activity (e.g., at least one of Pt, Rh, Ir, Ru, and Pd) as the metal component. The ceramic component to be used is not particularly limited, but is preferably an oxygen-ion-conductive solid electrolyte as in the case of the base part 102. For example, the second measurement electrode 44 may be a porous cermet electrode made of Pt and ZrO₂.

In the second measurement pump cell 41, by applying a pump voltage (second measurement pump voltage) Vp2 between the second measurement electrode 44 and the outer pump electrode 23 by a variable power supply 46 to make a second measurement pump current (carbon dioxide detecting current) Ip2 flow between the second measurement electrode 44 and the outer pump electrode 23, it is possible to pump oxygen into the third internal cavity 61. In FIG. 1, a direction of pumping oxygen into the third internal cavity 61 is illustrated as a negative direction.

To detect the oxygen partial pressure around the second measurement electrode 44, the first solid electrolyte layer 4, the third substrate layer 3, the second measurement electrode 44, and the reference electrode 42 constitute an electrochemical sensor cell, namely an oxygen-partial-pressure detection sensor cell 82 for second measurement pump control. In the oxygen-partial-pressure detection sensor cell 82 for second measurement pump control, an electromotive force (a voltage V2) is generated between the second measurement electrode 44 and the reference electrode 42 due to a difference in oxygen concentration between an atmosphere in the third internal cavity 61 and a reference gas in the reference gas introduction space 43.

The oxygen concentration (oxygen partial pressure) in the third internal cavity 61 can be detected from the voltage V2 measured in the oxygen-partial-pressure detection sensor cell 82 for second measurement pump control. The pump voltage Vp2 in the variable power supply 46 is feedback controlled on the basis of the voltage V2 detected by the oxygen-partial-pressure detection sensor cell 82 for second measurement pump control.

Also, the second solid electrolyte layer 6, the spacer layer 5, the first solid electrolyte layer 4, the third substrate layer 3, the outer pump electrode 23, and the reference electrode 42 constitute an electrochemical sensor cell 83, and it is possible to detect the oxygen partial pressure in the measurement-object gas outside the sensor by an electromotive force (a voltage Vref) obtained by the sensor cell 83. Thus, a function as an oxygen concentration cell may be added to the gas sensor 100.

The sensor element 101 further includes a heater part 70 that functions as a temperature regulator of heating and maintaining the temperature of the sensor element 101 so as to enhance the oxygen ion conductivity of the solid electrolyte. The heater part 70 includes a heater electrode 71, a heater 72, a heater lead 76, a through hole 73, a heater insulating layer 74, and a pressure relief vent 75.

The heater electrode 71 is an electrode formed in contact with the lower surface of the first substrate layer 1. The power can be supplied to the heater part 70 from the outside by connecting the heater electrode 71 with an external power supply.

The heater 72 is an electrical resistor sandwiched by the second substrate layer 2 and the third substrate layer 3 from top and bottom. The heater 72 is connected with the heater electrode 71 via the heater lead 76 that connects with the heater 72 and extends in the rear end side in the longitudinal direction of the sensor element 101, and the through hole 73. The heater 72 is externally powered through the heater electrode 71 to generate heat, and heats and maintains the temperature of the solid electrolyte forming the sensor element 101.

The heater 72 is embedded over the whole area from the first internal cavity 20 to the third internal cavity 61 so that the temperature of the sensor element 101 can be adjusted to such a temperature that activates the solid electrolyte. The temperature may be adjusted so that the main pump cell 21, the first measurement pump cell 50, and the second measurement pump cell 41 are operable. It is not necessary that the whole area is adjusted to the same temperature, but the sensor element 101 may have temperature distribution. The sensor element 101 (base part 102) may have temperature distribution in the longitudinal direction, and may have temperature distribution in a thickness direction and/or a width direction. For example, the sensor element 101 may be heated so that temperature of the solid electrolyte around the measurement-object gas flow cavity 15 and the respective electrodes becomes at about 750° C. to about 900° C.

In the sensor element 101 of the present embodiment, the heater 72 is embedded in the base part 102, but this form is not limitative. The heater 72 may be disposed to heat the base part 102. That is, the heater 72 may heat the sensor element 101 to develop oxygen ion conductivity with which the main pump cell 21, the first measurement pump cell 50, and the second measurement pump cell 41 are operable. For example, the heater 72 may be embedded in the base part 102 as in the present embodiment. Alternatively, for example, the heater part 70 may be formed as a heater substrate that is separate from the base part 102, and may be disposed at a position adjacent to the base part 102.

The heater insulating layer 74 is formed of an insulator such as alumina on the upper and lower surfaces of the heater 72 and the heater lead 76. The heater insulating layer 74 is formed to ensure electrical insulation between the second substrate layer 2, and the heater 72 and the heater lead 76, and electrical insulation between the third substrate layer 3, and the heater 72 and the heater lead 76.

The pressure relief vent 75 extends through the third substrate layer 3 so that the heater insulating layer 74 and the reference gas introduction space 43 communicate with each other. The pressure relief vent 75 can mitigate an increase in internal pressure due to temperature rise in the heater insulating layer 74. The pressure relief vent 75 may be absent.

Further, an area of a predetermined length in the longitudinal direction in a surface of the sensor element 101 from the front end may be covered by a porous protective layer not shown. The porous protective layer is formed to protect a region where the internal cavities and the electrodes are present in the sensor element 101 from thermal shock caused by water splashing or the like. The porous protective layer may be made of ceramics such alumina, and may have a thickness of approximately 10 μm to 2000 μm. Preferably, the porous protective layer may be formed so as to resist forces up to approximately 50 N.

The above-described sensor element 101 is incorporated into the gas sensor 100 in such a form that the front end part of the sensor element 101 comes into contact with the measurement-object gas, and the rear end part of the sensor element 101 comes into contact with the reference gas.

### (Control Unit)

The gas sensor 100 of this embodiment includes the sensor element 101 described above and the control unit 90 for controlling the sensor element 101. In the gas sensor 100, each of the electrodes 22, 23, 51, 44, and 42 of the sensor element 101 is electrically connected to the control unit 90 through a lead wire not shown. FIG. 2 is a block diagram showing electric connections between the control unit 90 and the respective pump cells 21, 50 and 41, and the respective sensor cells 80, 81, 82, and 83 of the sensor element 101. The control unit 90 includes the above-described variable power supplies 24, 52 and 46, and a control part 91. The control part 91 includes a pump control part 92 and a concentration calculating part 93.

The control part 91 is realized by a general-purpose or dedicated computer, and functions as the pump control part 92 and the concentration calculating part 93 are realized by a CPU, a memory or the like installed in the computer. It is to be noted that when water vapor H₂O and carbon dioxide CO₂ contained in exhaust gas from the engine of a car is target gases to be measured by the gas sensor 100 and the sensor element 101 is attached to an exhaust gas path, some or all of the functions of the control unit 90 (especially, the control part 91) may be realized by an electronic control unit (ECU) installed in the car.

The control part 91 is configured to acquire an electromotive force (voltage V0, V1, V2, Vref) in each of the sensor cells 80, 81, 82, and 83, and a pump current (Ip0, Ip1, Ip2) in each of the pump cells 21, 50 and 41 of the sensor element 101. Further, the control part 91 is configured to output control signals to the variable power supplies 24, 52 and 46.

The pump control part 92 is configured to control the operation of the oxygen pump cell (in this embodiment, the main pump cell 21), the first measurement pump cell 50, and the second measurement pump cell 41 so as to measure a water vapor concentration and a carbon dioxide concentration in a measurement-object gas.

The pump control part 92 applies a predetermined oxygen pump voltage (pump voltage Vp0) between the intracavity oxygen pump electrode (the inner main pump electrode 22) and the extracavity oxygen pump electrode (the outer pump electrode 23) of the oxygen pump cell (the main pump cell 21) to pump out oxygen from the first internal cavity 20 and adjust an oxygen partial pressure in the first internal cavity 20 such that substantially all of water vapor and carbon dioxide in the measurement-object gas are decomposed in the first internal cavity 20;
the pump control part 92 applies a predetermined first measurement pump voltage (pump voltage Vp1) between the intracavity first measurement electrode (the first measurement electrode 51) and the extracavity first measurement electrode (the outer pump electrode 23) of the first measurement pump cell 50 to pump oxygen into the second internal cavity 40 and adjust an oxygen partial pressure in the second internal cavity 40 such that hydrogen generated by decomposition of the water vapor is selectively oxidized in the second internal cavity 40; and
the pump control part 92 applies a predetermined second measurement pump voltage (pump voltage Vp2) between the intracavity second measurement electrode (the second measurement electrode 44) and the extracavity second measurement electrode (the outer pump electrode 23) of the second measurement pump cell 41 to pump oxygen into near a surface of the intracavity second measurement electrode (the second measurement electrode 44), namely, into the third internal cavity 61, and adjust an oxygen partial pressure in the third internal cavity 61 such that carbon monoxide generated by decomposition of the carbon dioxide is selectively oxidized near the surface of the intracavity second measurement electrode (the second measurement electrode 44).

The pump control part 92 may adjust the oxygen partial pressure in each of the internal cavities 20, 40, and 61 by adjusting the pump voltage (Vp0, Vp1, Vp2) in each of the pump cells 21, 50, and 41. Further, the pump control part 92 may adjust the oxygen partial pressure in each of the internal cavities 20, 40, and 61 by performing, for example, the following feedback control based on the electromotive force (voltage V0, V1, V2) generated in each of the sensor cells 80, 81, and 82. Specifically, in the present embodiment, control is performed in the following manner.

The pump control part 92 performs feedback control of the pump voltage Vp0 of the variable power supply 24 in the main pump cell 21 so that the electromotive force (the voltage V0) generated between the intracavity oxygen pump electrode (the inner main pump electrode 22) and the reference electrode 42 is at a constant value (referred to as a set value V0_{SET}). The set value V0_{SET} may be set as a value such that the oxygen partial pressure of the atmosphere in the first internal cavity 20 is made to be an oxygen partial pressure at which all of, or substantially all of the water vapor and the carbon dioxide in the measurement-object gas is decomposed in the first internal cavity 20. The set value V0_{SET} may vary depending on the intended use of the gas sensor 100, the configuration of the sensor element 101 and the like, and the set value V0_{SET} may be, for example, about 1200 mV or more and about 1500 mV or less, or, about 1300 mV or more and about 1500 mV or less.

The pump control part 92 performs feedback control of the pump voltage Vp1 of the variable power supply 52 in the first measurement pump cell 50 so that the electromotive force (the voltage V1) generated between the intracavity first measurement electrode (the first measurement electrode 51) and the reference electrode 42 is at a constant value (referred to as a set value V1_{SET}). The set value V1_{SET} may be set as a value such that the oxygen partial pressure of the atmosphere in the second internal cavity 40 is made to be an oxygen partial pressure at which the hydrogen generated by the decomposition of the water vapor is selectively burned in the second internal cavity 40. That is, the set value V1_{SET} may be set as a value such that the oxygen partial pressure of the atmosphere in the second internal cavity 40 is made to be an oxygen partial pressure at which all of, or substantially all of the hydrogen generated by the decomposition of the water vapor is burned in the vicinity of the surface of the intracavity first measurement electrode (the first measurement electrode 51) in the second internal cavity 40, and the carbon monoxide generated by the decomposition of the carbon dioxide is not burned, or at least a part of the carbon monoxide is not burned in the vicinity of the surface of the intracavity first measurement electrode (the first measurement electrode 51) in the second internal cavity 40. The set value V1_{SET} may vary depending on the intended use of the gas sensor 100, the configuration of the sensor element 101 and the like, and the set value V1_{SET} may be, for example, about 200 mV or more and about 700 mV or less. The set value V1_{SET} may be, for example, about 350 mV.

The pump control part 92 performs feedback control of the pump voltage Vp2 of the variable power supply 46 in the second measurement pump cell 41 so that the electromotive force (the voltage V2) generated between the intracavity second measurement electrode (the second measurement electrode 44) and the reference electrode 42 is at a constant value (referred to as a set value V2_{SET}). The set value V2_{SET} may be set as a value such that the oxygen partial pressure of the atmosphere in the vicinity of the surface of the intracavity second measurement electrode (the second measurement electrode 44), namely, in the third internal cavity 61 is made to be an oxygen partial pressure at which the carbon monoxide generated by the decomposition of the carbon dioxide is selectively burned in the vicinity of the surface of the intracavity second measurement electrode (the second measurement electrode 44). That is, the set value V2_{SET} may be set as a value such that the oxygen partial pressure in the vicinity of the surface of the intracavity second measurement electrode (the second measurement electrode 44) is made to be an oxygen partial pressure at which all of, or substantially all of the carbon monoxide generated by the decomposition of the carbon dioxide is burned in the vicinity of the surface of the intracavity second measurement electrode (the second measurement electrode 44). The set value V2_{SET} is generally a value smaller than the set value V1_{SET}. The set value V2_{SET} may vary depending on the intended use of the gas sensor 100, the configuration of the sensor element 101 and the like, and the set value V2_{SET} may be, for example, about 150 mV or more and about 400 mV or less. The set value V2_{SET} may be, for example, about 200 mV.

The concentration calculating part 93 is configured to calculate a carbon dioxide concentration and a water vapor concentration in a measurement-object gas.

The concentration calculating part 93 is configured to calculate a carbon dioxide concentration and a water vapor concentration in a measurement-object gas by:
considering an oxygen pump current flowing through the oxygen pump cell as a function of the carbon dioxide concentration, the water vapor concentration and an oxygen concentration in the measurement-object gas,
considering a first measurement pump current flowing through the first measurement pump cell as a function of the water vapor concentration in the measurement-object gas, and the carbon dioxide concentration and/or the oxygen concentration in the measurement-object gas, and
considering a second measurement pump current flowing through the second measurement pump cell as a function of the carbon dioxide concentration in the measurement-object gas, and the water vapor concentration and/or the oxygen concentration in the measurement-object gas.

The concentration calculating part 93 previously stores:
a conversion formula for the oxygen pump current (in this embodiment, a conversion formula for the main pump current; namely, a Ip0 conversion formula) expressing the oxygen pump current (namely, the main pump current Ip0) as the function of the carbon dioxide concentration, the water vapor concentration and the oxygen concentration in the measurement-object gas,
a conversion formula for the first measurement pump current (namely, a Ip1 conversion formula) expressing the first measurement pump current as the function of the water vapor concentration in the measurement-object gas, and the carbon dioxide concentration and/or the oxygen concentration in the measurement-object gas, and
a conversion formula for the second measurement pump current (namely, a Ip2 conversion formula) expressing the second measurement pump current as the function of the carbon dioxide concentration in the measurement-object gas, and the water vapor concentration and/or the oxygen concentration in the measurement-object gas. In this embodiment, each of the conversion formulas (Ip0 conversion formula, Ip1 conversion formula, and Ip2 conversion formula) is expressed as a function of the carbon dioxide concentration, the water vapor concentration and the oxygen concentration in the measurement-object gas. These conversion formulas are previously stored in the memory of the control part 91 which functions as the concentration calculating part 93. Each of the conversion formulas (Ip0 conversion formula, Ip1 conversion formula, and Ip2 conversion formula) may appropriately be determined by those skilled in the art by, for example, previously performing an experiment on the gas sensor 100. Each of the conversion formulas (Ip0 conversion formula, Ip1 conversion formula, and Ip2 conversion formula) may be, for example, an approximate expression obtained by experiment. Each of the conversion formulas may be specific to each individual gas sensor 100 or may be common to a plurality of gas sensors. Details of the conversion formulas will be described later.

The concentration calculating part 93 acquires the main pump current Ip0 flowing through the oxygen pump cell (namely, the main pump cell 21), the first measurement pump current Ip1 flowing through the first measurement pump cell 50, and the second measurement pump current Ip2 flowing through the second measurement pump cell 41, and substitutes the pump currents into the previously-stored conversion formulas, respectively. That is, the concentration calculating part 93 substitutes the acquired main pump current Ip0 into the Ip0 conversion formula, substitutes the acquired first measurement pump current Ip1 into the Ip1 conversion formula, and substitutes the acquired second measurement pump current Ip2 into the Ip2 conversion formula to create simultaneous equations consisting of three equations with the carbon dioxide concentration, the water vapor concentration and the oxygen concentration as variables. The concentration calculating part 93 calculates the carbon dioxide concentration, the water vapor concentration and the oxygen concentration by executing numerical analysis of the simultaneous equations.

### Measurement of Water Vapor Concentration and Carbon Dioxide Concentration

Next, a method for measuring each concentration of carbon dioxide CO₂ and water vapor H₂O in the measurement-object gas by using the gas sensor 100 having such a configuration as described above will be described.

The measurement-object gas is introduced from the gas inlet 10, passes through the first diffusion-rate limiting path 11, the buffer space 12, and the auxiliary diffusion-rate limiting path 13 in this order so that a predetermined diffusion resistance is imparted to the measurement-object gas, and reaches the first internal cavity 20.

In the first internal cavity 20, by operating the main pump cell 21 as described above, the pump control part 92 pumps out oxygen from the first internal cavity 20 so that the oxygen partial pressure of the measurement-object gas introduced into the first internal cavity 20 is made to be a low oxygen partial pressure (for example, about 10⁻¹⁰ to 10⁻³⁰ atm) at which all of, or substantially all of water vapor and carbon dioxide contained in the measurement-object gas are decomposed. “All of, or substantially all of water vapor and carbon dioxide contained in the measurement-object gas are decomposed” means that the water vapor and the carbon dioxide introduced into the first internal cavity 20 are not substantially introduced into the second internal cavity 40.

When oxygen is pumped out from the first internal cavity 20 in such a manner, the decomposition reaction of water vapor (2H₂O→2H₂+O₂) and the decomposition reaction of carbon dioxide (2CO₂→2CO+O₂) are promoted in the first internal cavity 20 (especially, in the vicinity of the surface of the inner main pump electrode 22). Hydrogen and oxygen are generated by the decomposition of the water vapor, and carbon monoxide and oxygen are generated by the decomposition of the carbon dioxide. The generated oxygen is pumped out together with oxygen gas originally present in the measurement-object gas by the main pump cell 21. On the other hand, the hydrogen and the carbon monoxide are introduced into the second internal cavity 40.

The set value V0_{SET} of the voltage V0 may be preferably set such that an oxygen partial pressure (a target oxygen partial pressure) after adjusted in the first internal cavity 20 becomes smaller as the oxygen partial pressure in the measurement-object gas that has reached the first internal cavity 20 becomes larger. This may allow oxygen to be pumped out more reliably.

The measurement-object gas, which contains the hydrogen generated by the decomposition of the water vapor and the carbon monoxide generated by the decomposition of the carbon dioxide, passes through the second diffusion-rate limiting path 30 so that a predetermined diffusion resistance is imparted to the measurement-object gas, and reaches the second internal cavity 40.

In the second internal cavity 40, by operating the first measurement pump cell 50 as described above, the pump control part 92 pumps oxygen into the second internal cavity 40. Consequently, hydrogen in the measurement-object gas containing hydrogen and carbon monoxide, which has reached the vicinity of the surface of the first measurement electrode 51 in the second internal cavity 40, selectively reacts with oxygen existing at this position for burning (2H₂+O₂→2H₂O). Oxygen may be pumped in by the first measurement pump cell 50 so that substantially all of the hydrogen having reached the vicinity of the surface of the first measurement electrode 51 is burned. Thus, in the measurement-object gas, the hydrogen generated by the decomposition of the water vapor is not present, and the carbon monoxide generated by the decomposition of the carbon dioxide is contained. For example, oxygen may be pumped in by the first measurement pump cell 50 so that the oxygen partial pressure in the second internal cavity 40, especially, in the vicinity of the surface of the first measurement electrode 51, is made to be at 10⁻⁵ atm to 10⁻¹⁵ atm.

The measurement-object gas, in which the hydrogen generated by the decomposition of the water vapor has been burned and the carbon monoxide generated by the decomposition of the carbon dioxide is contained, passes through the third diffusion-rate limiting path 60 so that a predetermined diffusion resistance is imparted to the measurement-object gas, and reaches the third internal cavity 61.

By operating the second measurement pump cell 41 as described above, the pump control part 92 pumps oxygen into the third internal cavity 61. Consequently, carbon monoxide in the measurement-object gas containing the carbon monoxide, which has reached the vicinity of the surface of the second measurement electrode 44 in the third internal cavity 61, selectively reacts with oxygen existing at this position for burning (2CO+O₂→2CO₂). Oxygen may be pumped in by the second measurement pump cell 41 so that substantially all of the carbon monoxide having reached the vicinity of the surface of the second measurement electrode 44 is burned. For example, oxygen may be pumped in by the second measurement pump cell 41 so that the oxygen partial pressure in the third internal cavity 61, especially, in the vicinity of the surface of the second measurement electrode 44, is made to be at 10⁻⁵ atm to 10⁻¹⁵ atm.

If the measurement-object gas introduced through the gas inlet 10 contains no water vapor, decomposition of water vapor does not occur in the first internal cavity 20, and thus, hydrogen is not introduced into the second internal cavity 40. However, to keep the voltage V1 at the set value V1_{SET}, a slight amount of the water vapor detecting current Ip1 (so-called an offset current) generally may flow. Also, if the measurement-object gas introduced through the gas inlet 10 contains no carbon dioxide, decomposition of carbon dioxide does not occur in the first internal cavity 20, and thus, carbon monoxide is not introduced into the third internal cavity 61. However, to keep the voltage V2 at the set value V2_{SET}, a slight amount of the carbon dioxide detecting current Ip2 (so-called an offset current) generally may flow.

The above-described manner of controlling an oxygen partial pressure facilitates selective burning of hydrogen near the surface of the first measurement electrode 51 and selective burning of carbon monoxide on the surface of the second measurement electrode 44. This is because due to a difference in gas diffusion rate between hydrogen and carbon monoxide, hydrogen has a higher gas diffusion rate and is more likely to come into contact with oxygen for burning than carbon monoxide, and hydrogen is more likely to combine with oxygen, that is, is more likely to burn, than carbon monoxide.

Measurement principle of such a gas sensor 100 is ideally as follows. In the first internal cavity 20, substantially all of water vapor and carbon dioxide in the measurement-object gas are decomposed, and substantially all of oxygen originally contained in the measurement-object gas and oxygen generated by the decomposition of the water vapor and the carbon dioxide are pumped out by the main pump cell 21. The main pump current Ip0 flowing through the main pump cell 21 at this time is substantially proportional to a total amount of an amount of the oxygen originally contained in the measurement-object gas and an amount of the oxygen generated by the decomposition of the water vapor and the carbon dioxide. The amount of the oxygen generated by the decomposition of the water vapor and the carbon dioxide is correlated with each of an amount (or, a concentration) of water vapor and an amount (or, a concentration) of carbon dioxide in the measurement-object gas. Therefore, the pump current Ip0 is to be a value corresponding to the carbon dioxide concentration, the water vapor concentration and the oxygen concentration (roughly a total concentration of the carbon dioxide concentration, the water vapor concentration and the oxygen concentration) in the measurement-object gas.

In the second internal cavity 40, oxygen is pumped in by the first measurement pump cell 50 so that substantially all of the hydrogen generated by the decomposition of the water vapor is oxidized but the carbon monoxide generated by the decomposition of the carbon dioxide is not substantially oxidized. The first measurement pump current (water vapor detecting current) Ip1 flowing through the first measurement pump cell 50 at this time is substantially proportional to an amount (or, a concentration) of the hydrogen burning in the vicinity of the surface of the first measurement electrode 51. An amount of hydrogen having reached the vicinity of the surface of the first measurement electrode 51 is correlated with an amount of water vapor contained in the measurement-object gas introduced through the gas inlet 10.

In the third internal cavity 61, oxygen is pumped in by the second measurement pump cell 41 so that substantially all of the carbon monoxide generated by the decomposition of the carbon dioxide is oxidized. The second measurement pump current (carbon dioxide detecting current) Ip2 flowing through the second measurement pump cell 41 at this time is substantially proportional to an amount (or, a concentration) of the carbon monoxide burning in the vicinity of the surface of the second measurement electrode 44. An amount of carbon monoxide having reached the vicinity of the surface of the second measurement electrode 44 is correlated with an amount of carbon dioxide contained in the measurement-object gas introduced through the gas inlet 10.

Therefore, ideally, the concentration calculating part 93 can calculate the water vapor concentration based only on the first measurement pump current Ip1, and calculate the carbon dioxide concentration based only on the second measurement pump current Ip2. Further, the concentration calculating part 93 can calculate the oxygen concentration based on the calculated water vapor concentration and carbon dioxide concentration, and the main pump current Ip0. Thus, each concentration of three gas types, namely, carbon dioxide, water vapor and oxygen, can be measured simultaneously (or, in parallel).

In such an ideal case, when a carbon dioxide concentration in the measurement-object gas is represented as X, a water vapor concentration is represented as Y, and an oxygen concentration is represented as Z, the respective pump currents Ip0, Ip1 and Ip2 can be expressed by the following Equations (1) to (3).

$$Ip 0 = ( aX + bY + cZ ) \qquad ( 1 )$$

$$Ip 1 = ( fY ) \qquad ( 2 )$$

$$Ip 2 = ( hX ) \qquad ( 3 )$$

Here, “a”, “b”, “c”, “f”, and “h” are coefficients of respective terms.

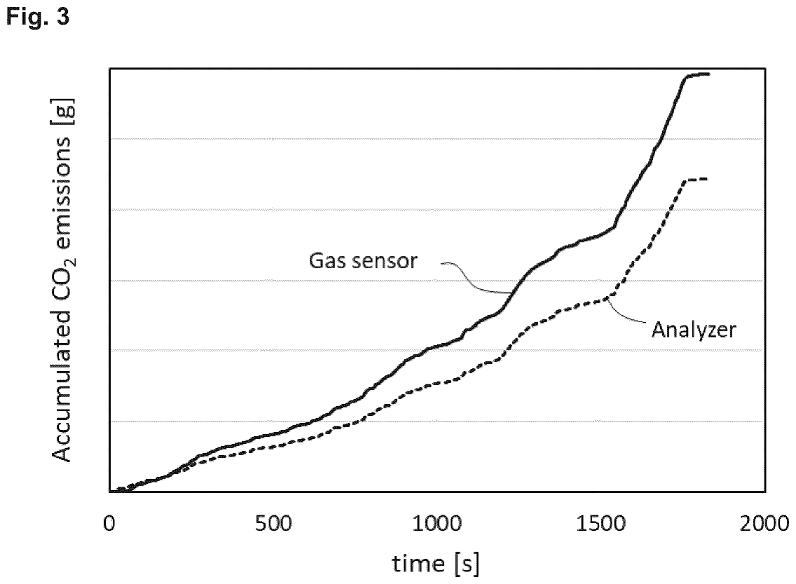

An example of calculating the carbon dioxide concentration based on only the second measurement pump current Ip2 as Equation (3) in the gas sensor 100 is shown in FIG. 3. FIG. 3 is a graph showing one example of measurement results of CO₂ emissions in WLTC (Worldwide-harmonized Light vehicles Test Cycle) mode. The horizontal axis of the graph represents time [seconds; s], and the vertical axis of the graph represents accumulated CO₂ emissions [g]. The WLTC (Worldwide-harmonized Light vehicles Test Cycle) mode is a driving cycle used for measuring fuel efficiency of an automobile, and an international driving cycle composed of city, suburban, and highway driving modes, weighted according to their average usage time distribution. The accumulated CO₂ emissions is an accumulated value by accumulating the CO₂ emissions derived from the CO₂ concentration in an exhaust gas and a MAF flow rate when the automobile is driven in the WLTC mode, by multiplying the CO₂ concentration by the MAF flow rate and density correction. The MAF flow rate is a measured value of a MAF (Mass Air Flow) sensor installed on the automobile. The density correction is correction with a correction value obtained from a ratio of atmospheric density (1.293 kg/m³) and CO₂ density (1.964 g/L), under the assumption that the exhaust density is equal to the atmospheric density (1.293 kg/m³). In FIG. 3, the result using the measurement results of the analyzer as the CO₂ concentration are shown with a dotted line, and the result using the CO₂ concentration calculating only from the second measurement pump current Ip2 of the gas sensor 100 is shown with a solid line. It has been found that the CO₂ emissions obtained using the gas sensor 100 deviate by approximately 20 to 35% (deviation of 33.6% in the example of FIG. 3) from the CO₂ emissions obtained using the analyzer as the reference, in the entire WLTC mode, that is, at the end point of the WLTC mode (namely, at the time point of 1800 seconds). It has been also found that the CO₂ emissions obtained using the gas sensor 100 deviate in a direction of being higher than the CO₂ emissions obtained using the analyzer.

Thus, actually, the measurement value of the CO₂ concentration in the gas sensor 100 has been found to deviate from the CO₂ concentration in the analyzer, which is considered to indicate an actual CO₂ concentration in the exhaust gas. The reason is considered to be as follows. The coexisting three gas components (namely, carbon dioxide, water vapor and oxygen) interfere with each other. Therefore, the first measurement pump current Ip1 varies not only by the water vapor concentration, but also by the carbon dioxide concentration and the oxygen concentration, that is, receives interference from the carbon dioxide concentration and the oxygen concentration. The property of the first measurement pump current Ip1 being affected from the carbon dioxide concentration is also referred to as carbon dioxide interference (CO₂ interference), and the property of the first measurement pump current Ip1 being affected from the oxygen concentration is also referred to as oxygen interference (O₂ interference). Further, the second measurement pump current Ip2 varies not only by the carbon dioxide concentration, but also by the water vapor concentration and the oxygen concentration, that is, receives interference from the water vapor concentration and the oxygen concentration. The property of the second measurement pump current Ip2 being affected from the water vapor concentration is also referred to as water vapor interference (H₂O interference), and the property of the second measurement pump current Ip2 being affected from the oxygen concentration is also referred to as oxygen interference (O₂ interference).

The present inventors considered that in the gas sensor 100, the water vapor concentration and the carbon dioxide concentration can be measured more accurately by correcting the above-described interference. In the gas sensor 100, as a result of control of the pump control part 92, the main pump current Ip0, the first measurement pump current Ip1, and the second measurement pump current Ip2 are obtained, and each of these three currents is affected from three gas components, namely, carbon dioxide, water vapor and oxygen, as described above. This makes it difficult to calculate each of a carbon dioxide concentration, a water vapor concentration and an oxygen concentration individually. As a result of intensive studies, the present inventors have found that the carbon dioxide concentration, the water vapor concentration and the oxygen concentration can be accurately calculated from the main pump current Ip0, the first measurement pump current Ip1, and the second measurement pump current Ip2 by using numerical analysis.

As described above, the concentration calculating part 93 calculates a carbon dioxide concentration and a water vapor concentration in a measurement-object gas by:
considering an oxygen pump current flowing through the oxygen pump cell as a function of the carbon dioxide concentration, the water vapor concentration and an oxygen concentration in the measurement-object gas,
considering a first measurement pump current flowing through the first measurement pump cell as a function of the water vapor concentration in the measurement-object gas, and the carbon dioxide concentration and/or the oxygen concentration in the measurement-object gas, and
considering a second measurement pump current flowing through the second measurement pump cell as a function of the carbon dioxide concentration in the measurement-object gas, and the water vapor concentration and/or the oxygen concentration in the measurement-object gas. The concentration calculating part 93 may further calculate the oxygen concentration.

More specifically, the concentration calculating part 93 previously stores:
a conversion formula for the oxygen pump current (in this embodiment, a conversion formula for the main pump current; namely, a Ip0 conversion formula) expressing the oxygen pump current (namely, the main pump current Ip0) as the function of the carbon dioxide concentration, the water vapor concentration and the oxygen concentration in the measurement-object gas,
a conversion formula for the first measurement pump current (namely, a Ip1 conversion formula) expressing the first measurement pump current as the function of the water vapor concentration in the measurement-object gas, and the carbon dioxide concentration and/or the oxygen concentration in the measurement-object gas, and
a conversion formula for the second measurement pump current (namely, a Ip2 conversion formula) expressing the second measurement pump current as the function of the carbon dioxide concentration in the measurement-object gas, and the water vapor concentration and/or the oxygen concentration in the measurement-object gas; and
the concentration calculating part 93 substitutes a value of the oxygen pump current (namely, the main pump current Ip0) flowing through the oxygen pump cell (namely, the main pump cell 21) into the conversion formula for the oxygen pump current (namely, the Ip0 conversion formula), substitutes a value of the first measurement pump current Ip1 flowing through the first measurement pump cell 50 into the conversion formula for the first measurement pump current (namely, the Ip1 conversion formula), and substitutes a value of the second measurement pump current Ip2 flowing through the second measurement pump cell 41 into the conversion formula for the second measurement pump current (namely, the Ip2 conversion formula), and
the concentration calculating part 93 executes numerical analysis of the substituted conversion formula for the oxygen pump current (namely, the Ip0 conversion formula), conversion formula for the first measurement pump current (namely, the Ip1 conversion formula), and conversion formula for the second measurement pump current (namely, the Ip2 conversion formula) to calculate the carbon dioxide concentration and the water vapor concentration. The concentration calculating part 93 may further calculate the oxygen concentration.

When a carbon dioxide concentration in the measurement-object gas is represented as X, a water vapor concentration is represented as Y, and an oxygen concentration is represented as Z, the conversion formula for the main pump current Ip0 (namely, the Ip0 conversion formula) is expressed as a function of the carbon dioxide concentration X, the water vapor concentration Y, and the oxygen concentration Z. That is,

$$Ip 0 = f ( X , Y , Z ) .$$

The conversion formula for the first measurement pump current Ip1 (namely, the Ip1 conversion formula) is expressed as a function of the water vapor concentration Y, and the carbon dioxide concentration X and/or the oxygen concentration Z. That is,

$$Ip 1 = f ( X , Y ) ,$$

$$Ip 1 = f ( Y , Z ) , or$$

$$Ip 1 = f ( X , Y , Z ) .$$

The conversion formula for the second measurement pump current Ip2 (namely, the Ip2 conversion formula) is expressed as a function of the carbon dioxide concentration X, and the water vapor concentration Y and/or the oxygen concentration Z. That is,

$$Ip 2 = f ( X , Y ) ,$$

$$Ip 2 = f ( X , Z ) , or$$

$$Ip 2 = f ( X , Y , Z ) .$$

More specifically, the Ip0 conversion formula, the Ip1 conversion formula, and the Ip2 conversion formula may be, for example, functions as follows. “a” to “k” are coefficients of respective terms. “*” represents multiplication (hereinafter the same shall apply).

$$Ip 0 = ( aX + bY ) * ( 1 + dZ ) + cZ \qquad ( 4 )$$

$$Ip 1 = ( eX + fY ) * ( 1 + gZ ) \qquad ( 5 )$$

$$Ip 2 = ( hX ) * ( i + jY ) * ( 1 + kZ ) \qquad ( 6 )$$

As shown in Equation (4), the Ip0 conversion formula may be a formula in which a term “aX” regarding the carbon dioxide concentration, a term “bY” regarding the water vapor concentration and a term “cZ” regarding the oxygen concentration are added together, and also the term “aX” regarding the carbon dioxide concentration, and the term “bY” regarding the water vapor concentration are multiplied by a second term “1+dZ” regarding the oxygen concentration. Equation (4) incorporates, into the above Equation (1), the second term “1+dZ” regarding the oxygen concentration, that is, a term for correcting the oxygen interference. Thus, in the Ip0 conversion formula [Equation (4)], two terms regarding the oxygen concentration, namely, “1+dZ” and “cZ”, are present. The term “1+dZ” corrects a variation in an amount of oxygen generated by the decomposition of the water vapor and the carbon dioxide in a measurement-object gas due to the oxygen concentration in the measurement-object gas. The term “cZ” represents an amount of current flowing by pumping out oxygen in the measurement-object gas, that is, sensitivity with respect to the oxygen. The Ip0 conversion formula may not include the term “1+dZ” for correcting the oxygen interference. Equation (4) is a first degree polynomial equation for the carbon dioxide concentration X, a first degree polynomial equation for the water vapor concentration Y, and a first degree polynomial equation for the oxygen concentration Z. However, the Ip0 conversion formula is not limited thereto. The Ip0 conversion formula may be expressed as a polynomial equation of the second degree or more, or expressed as an exponent, a logarithm, or the like, for any one or more of the carbon dioxide concentration X, and the water vapor concentration Y and/or the oxygen concentration Z.

As shown in Equation (5), the Ip1 conversion formula may be a formula in which a term “eX” regarding the carbon dioxide concentration is added to a term “fY” regarding the water vapor concentration, and the term “eX” and the term “fY” are multiplied by a term “1+gZ” regarding the oxygen concentration. Equation (5) incorporates, into the above Equation (2), the term “eX” regarding the carbon dioxide concentration (that is, a term for correcting the carbon dioxide interference, more precisely, the sensitivity with respect to carbon dioxide), and the term “1+gZ” regarding the oxygen concentration (that is, a term for correcting the oxygen interference). The term “eX” corrects a current flowing for oxidizing, in the second internal cavity 40, a part of carbon monoxide generated by the decomposition of the carbon dioxide, that is corrects the sensitivity with respect to the carbon dioxide. The term “1+gZ” corrects a variation in an amount of hydrogen generated by the decomposition of the water vapor and an amount of the carbon monoxide generated by the decomposition of the carbon dioxide in the measurement-object gas due to oxygen concentration in the measurement-object gas. The Ip1 conversion formula may include at least one of the term “eX” for correcting the carbon dioxide interference, and the term “1+gZ” for correcting the oxygen interference. More preferably, the Ip1 conversion formula may include both of the term “eX” for correcting the carbon dioxide interference, and the term “1+gZ” for correcting the oxygen interference as shown in Equation (5). Equation (5) is a first degree polynomial equation for the carbon dioxide concentration X, a first degree polynomial equation for the water vapor concentration Y, and a first degree polynomial equation for the oxygen concentration Z. However, the Ip1 conversion formula is not limited thereto. The Ip1 conversion formula may be expressed as a polynomial equation of the second degree or more, or expressed as an exponent, a logarithm, or the like, for any one or more of the carbon dioxide concentration X, and the water vapor concentration Y and/or the oxygen concentration Z.

As shown in Equation (6), the Ip2 conversion formula may be a formula in which a term “hX” regarding the carbon dioxide concentration is multiplied by a term “i+jY” regarding the water vapor concentration and/or a term “1+kZ” regarding the oxygen concentration. Equation (6) incorporates, into the above Equation (3), the term “i+jY” regarding the water vapor concentration (that is, a term for correcting the water vapor interference), and the term “1+kZ” regarding the oxygen concentration (that is, a term for correcting the oxygen interference). The term “i+jY” corrects a variation in an amount of carbon monoxide reaches the third internal cavity 61 in the carbon monoxide generated by the decomposition of the carbon dioxide due to the water vapor concentration. The term “1+kZ” corrects a variation in an amount of hydrogen generated by the decomposition of the water vapor and an amount of the carbon monoxide generated by the decomposition of the carbon dioxide in the measurement-object gas due to oxygen concentration in the measurement-object gas. The Ip2 conversion formula may include at least one of the term “i+jY” for correcting the water vapor interference, and the term “1+kZ” for correcting the oxygen interference. More preferably, the Ip2 conversion formula may include both of the term “i+jY” for correcting the water vapor interference, and the term “1+kZ” for correcting the oxygen interference as shown in Equation (6). Equation (6) is a first degree polynomial equation for the carbon dioxide concentration X, a first degree polynomial equation for the water vapor concentration Y, and a first degree polynomial equation for the oxygen concentration Z. However, the Ip2 conversion formula is not limited thereto. The Ip2 conversion formula may be expressed as a polynomial equation of the second degree or more, or expressed as an exponent, a logarithm, or the like, for any one or more of the carbon dioxide concentration X, and the water vapor concentration Y and/or the oxygen concentration Z.

The conversion formulas as shown in Equations (4) to (6) are stored in the concentration calculating part 93 in advance. These conversion formulas may be previously created by an experiment or the like. Specifically, each of the conversion formulas can be created by, for example, performing preliminary measurement as follows.

The preliminary measurement is conducted as follows. The gas sensor 100 is attached to a piping for measurement and driven. And, each of the pump currents Ip0, Ip1, and Ip2 is measured when a model gas flows through the piping for measurement. Measurements are performed while flowing a plurality of model gasses with different gas compositions. For example, each of the pump currents Ip0, Ip1, and Ip2 is measured when concentrations of two gases among carbon dioxide, water vapor and oxygen are fixed, and a concentration of one remaining gas is varied. For the gas whose concentration is varied, an approximate expression of the concentration and each pump current is obtained. An approximate expression of the concentration and each pump current is obtained for each of carbon dioxide, water vapor and oxygen, and the obtained approximate expressions are combined to create a conversion formula.

As the model gas, for example, a gas with the following composition may be used.

Model gases (referred to as model gases for CO₂) for evaluating sensitivity or interference with respect to carbon dioxide are:
oxygen concentration: 0% (constant),
water vapor concentration: 3% (constant),
carbon dioxide concentration: 0, 1, 3, 5, 10, 15, or 20%, and
the reminder is nitrogen.

Model gases (referred to as model gases for H₂O) for evaluating sensitivity or interference with respect to water vapor are:
oxygen concentration: 0% (constant),
water vapor concentration: 0, 1, 3, 5, 10, 15, or 20%,
carbon dioxide concentration: 0% (constant), and
the reminder is nitrogen.

Model gases (referred to as model gases for O₂ interference) for evaluating interference with respect to oxygen are:
oxygen concentration: 0, 5, 10, 15, or 20%,
water vapor concentration: 10% (constant),
carbon dioxide concentration: 10% (constant), and
the reminder is nitrogen.

Model gases (referred to as model gases for O₂ sensitivity) for evaluating sensitivity with respect to oxygen in the main pump current Ip0 are:
oxygen concentration: 0, 5, 10, 15, or 20%,
water vapor concentration: 0% (constant),
carbon dioxide concentration: 0% (constant), and
the reminder is nitrogen.

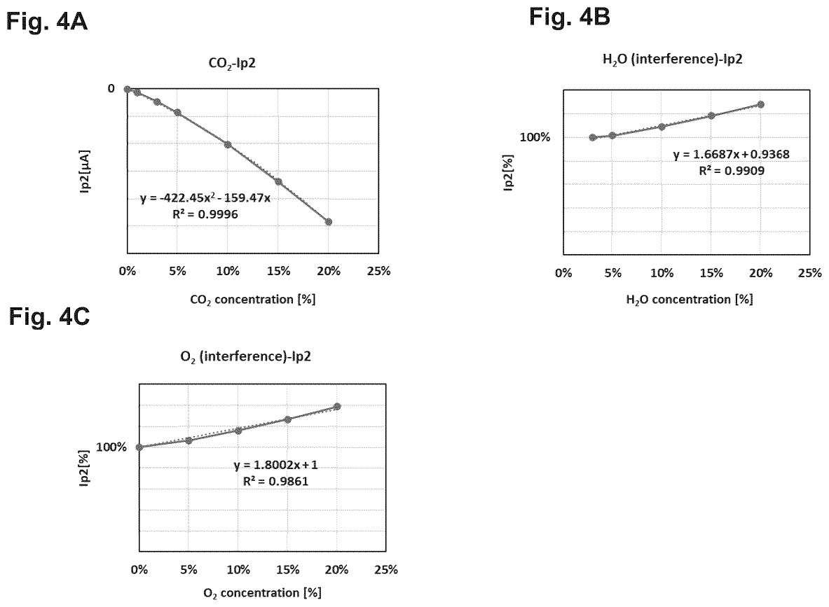

FIGS. 4A to 4C include graphs showing one example of the preliminary measurement results for calculating a conversion formula (Ip2 conversion formula) for the second measurement pump current Ip2. FIG. 4A is a graph showing the second measurement pump current Ip2 when water vapor concentration (H₂O concentration) and oxygen concentration (O₂ concentration) are at constant and only carbon dioxide concentration (CO₂ concentration) is varied. The horizontal axis of the graph represents the CO₂ concentration [%], and the vertical axis of the graph represents the second measurement pump current Ip2 [μA]. The graph shows one example of the measurement results using the above model gases for CO₂. The graph shows a sensitivity characteristic of the second measurement pump current Ip2 with respect to the CO₂ concentration. In FIG. 4A, an example of calculating a second-degree approximate expression with an intercept of zero is shown. FIG. 4B is a graph showing the second measurement pump current Ip2 when CO₂ concentration and O₂ concentration are at constant and only H₂O concentration is varied. The horizontal axis of the graph represents the H₂O concentration [%], and the vertical axis of the graph represents a relative value [%] of the second measurement pump current Ip2 when the second measurement pump current Ip2 at the H₂O concentration of 3% is set to 100%. The graph shows one example of the measurement results using the above model gases for H₂O (H₂O concentration of 3% or more). The graph shows H₂O interference of the second measurement pump current Ip2. In FIG. 4B, an example of calculating a first-degree approximate expression is shown. FIG. 4C is a graph showing the second measurement pump current Ip2 when CO₂ concentration and H₂O concentration are at constant and only O₂ concentration is varied. The horizontal axis of the graph represents the O₂ concentration [%], and the vertical axis of the graph represents a relative value [%] of the second measurement pump current Ip2 when the second measurement pump current Ip2 at the O₂ concentration of 0% is set to 100%. The graph shows one example of the measurement results using the above model gases for O₂ interference. The graph shows O₂ interference of the second measurement pump current Ip2. In FIG. 4C, an example of calculating a first-degree approximate expression with an intercept of one is shown.

The Ip2 conversion formula may be created from the approximate expressions calculated in FIGS. 4A, 4B, and 4C. In the examples of FIGS. 4A to 4C,
Ip2=(−422X²−159X)×(1.67Y+0.937)×(1.80Z+1) [μA].

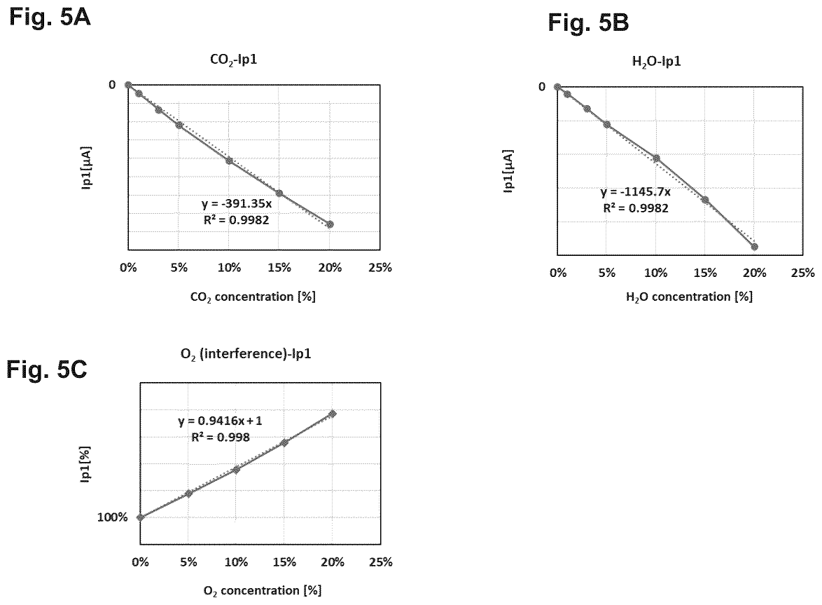

FIGS. 5A to 5C are graphs showing one example of the preliminary measurement results for calculating a conversion formula (Ip1 conversion formula) for the first measurement pump current Ip1. FIG. 5A is a graph showing the first measurement pump current Ip1 when H₂O concentration and O₂ concentration are at constant and only CO₂ concentration is varied. The horizontal axis of the graph represents the CO₂ concentration [%], and the vertical axis of the graph represents the first measurement pump current Ip1 [μA]. The graph shows one example of the measurement results using the above model gases for CO₂. The graph shows CO₂ interference of the first measurement pump current Ip1. In FIG. 5A, an example of calculating a first-degree approximate expression with an intercept of zero is shown. FIG. 5B is a graph showing the first measurement pump current Ip1 when CO₂ concentration and O₂ concentration are at constant and only H₂O concentration is varied. The horizontal axis of the graph represents the H₂O concentration [%], and the vertical axis of the graph represents the first measurement pump current Ip1 [μA]. The graph shows one example of the measurement results using the above model gases for H₂O. The graph shows a sensitivity characteristic of the first measurement pump current Ip1 with respect to the H₂O concentration. In FIG. 5B, an example of calculating a first-degree approximate expression with an intercept of zero is shown. FIG. 5C is a graph showing the first measurement pump current Ip1 when CO₂ concentration and H₂O concentration are at constant and only O₂ concentration is varied. The horizontal axis of the graph represents the O₂ concentration [%], and the vertical axis of the graph represents a relative value [%] of the first measurement pump current Ip1 when the first measurement pump current Ip1 at the O₂ concentration of 0% is set to 100%. The graph shows one example of the measurement results using the above model gases for O₂ interference. The graph shows O₂ interference of the first measurement pump current Ip1. In FIG. 5C, an example of calculating a first-degree approximate expression with an intercept of one is shown.

The Ip1 conversion formula may be created from the approximate expressions calculated in FIGS. 5A, 5B, and 5C. In the examples of FIGS. 5A to 5C,
Ip1=(−391X−1146Y)×(0.942Z+1) [μA].

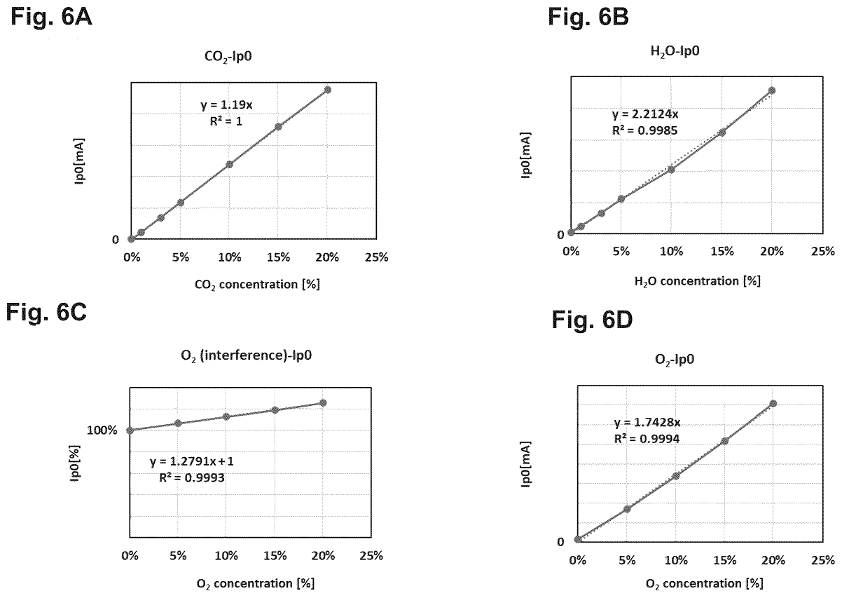

FIGS. 6A to 6D include graphs showing one example of the preliminary measurement results for calculating a conversion formula (Ip0 conversion formula) for the main pump current Ip0. FIG. 6A is a graph showing the main pump current Ip0 when H₂O concentration and O₂ concentration are at constant and only CO₂ concentration is varied. The horizontal axis of the graph represents the CO₂ concentration [%], and the vertical axis of the graph represents the main pump current Ip0 [mA]. The graph shows one example of the measurement results using the above model gases for CO₂. The graph shows a sensitivity characteristic of the main pump current Ip0 with respect to the CO₂ concentration. In FIG. 6A, an example of calculating a first-degree approximate expression with an intercept of zero is shown. FIG. 6B is a graph showing the main pump current Ip0 when CO₂ concentration and O₂ concentration are at constant and only H₂O concentration is varied. The horizontal axis of the graph represents the H₂O concentration [%], and the vertical axis of the graph represents the main pump current Ip0 [mA]. The graph shows one example of the measurement results using the above model gases for H₂O. The graph shows a sensitivity characteristic of the main pump current Ip0 with respect to the H₂O concentration. In FIG. 6B, an example of calculating a first-degree approximate expression with an intercept of zero is shown. FIG. 6C is a graph showing the main pump current Ip0 when CO₂ concentration and H₂O concentration are at constant (10% each) and only O₂ concentration is varied in the presence of CO₂ and H₂O. The horizontal axis of the graph represents the O₂ concentration [%], and the vertical axis of the graph represents a relative value [%] of the main pump current Ip0 when the main pump current Ip0 at the O₂ concentration of 0% is set to 100%. The graph shows one example of the measurement results using the above model gases for O₂ interference. The graph shows O₂ interference of the main pump current Ip0. In FIG. 6C, an example of calculating a first-degree approximate expression with an intercept of one is shown. FIG. 6D is a graph showing the main pump current Ip0 when CO₂ concentration and H₂O concentration are at constant (0% each) and only O₂ concentration is varied in the absence of CO₂ and H₂O. The horizontal axis of the graph represents the O₂ concentration [%], and the vertical axis of the graph represents the main pump current Ip0 [mA]. The graph shows one example of the measurement results using the above model gases for O₂ sensitivity. The graph shows a sensitivity characteristic of the main pump current Ip0 with respect to the O₂ concentration. In FIG. 6D, an example of calculating a first-degree approximate expression with an intercept of zero is shown.

The Ip0 conversion formula may be created from the approximate expressions calculated in FIGS. 6A, 6B, 6C and 6D. In the examples of FIGS. 6A to 6D,
Ip0=(1.19X+2.21Y)×(1.28Z+1)+1.74Z [mA].

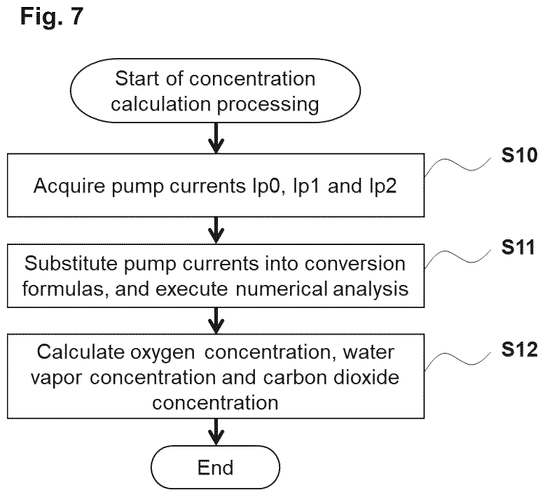

A method for calculating a carbon dioxide concentration, a water vapor concentration and an oxygen concentration in the measurement-object gas by using these three conversion formulas will be described. FIG. 7 is a flow chart of concentration calculating processing of each of a carbon dioxide concentration, a water vapor concentration and an oxygen concentration in a measurement-object gas. The concentration calculating processing is performed in a state where the gas sensor 100 is driven and the pump control part 92 performs the above control.

The concentration calculating part 93 acquires the main pump current Ip0, the first measurement pump current Ip1, and the second measurement pump current Ip2 (step S10). The concentration calculating part 93 substitutes the acquired current values of the pump currents Ip0, Ip1 and Ip2 into the respective conversion formulas, and executes numerical analysis (step S11). For the numerical analysis, various methods can be used. For example, Newton method, a bisection method, Jacobi method, a secant method, a stable method, or the like may be used, or a method other than these may be used. The concentration calculating part 93 calculates the values obtained by the numerical analysis as the carbon dioxide concentration, the water vapor concentration, and the oxygen concentration in the measurement-object gas (step S12).

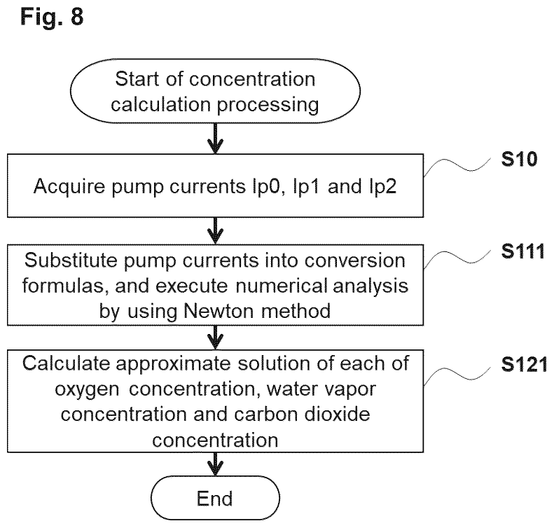

FIG. 8 is a flow chart of an example of the concentration calculating processing using Newton method. In FIG. 8, the same step as in FIG. 7 is denoted by the same sign. FIG. 8 is the flowchart when one set of approximate solutions is calculated by using Newton method. The concentration calculating part 93 substitutes the acquired current values of the pump currents Ip0, Ip1 and Ip2 into the respective conversion formulas, and executes the numerical analysis using Newton method (step S111). The concentration calculating part 93 obtains the approximate solutions of the carbon dioxide concentration, the water vapor concentration, and the oxygen concentration by Newton method to calculate them as the carbon dioxide concentration, the water vapor concentration, and the oxygen concentration in the measurement-object gas (step S121).

The gas sensor 100 has been described above as an example of the embodiment according to the present invention, but the present invention is not limited thereto. The present invention may include a gas sensor having any structure as long as the object of the present invention can be achieved, that is, a gas sensor that can accurately measure each concentration of multiple target gases to be measured in a measurement-object gas regardless of gas composition in the measurement-object gas is provided.

In the gas sensor 100 of the above-described embodiment, the concentration calculating part 93 is configured to output the carbon dioxide concentration and the water vapor concentration as measurement values of the gas sensor 100. However, the present invention is not limited thereto. The concentration calculating part 93 may be configured to output one of the carbon dioxide concentration and the water vapor concentration as the measurement value of the gas sensor 100. Further, since the concentration calculating part 93 obtains the carbon dioxide concentration and the water vapor concentration by the numerical analysis, the oxygen concentration is generally calculated at the same time. The concentration calculating part 93 may be configured to further output the oxygen concentration as a measurement value of the gas sensor 100.

In the sensor element 101, the inner main pump electrode 22 is composed of the ceiling electrode portion 22a formed on the ceiling surface of the first internal cavity 20, the bottom electrode portion 22b formed on the bottom surface of the first internal cavity 20, and the lateral electrode portions formed on the lateral wall surfaces of the first internal cavity 20 so as to connect the ceiling electrode portion 22a and the bottom electrode portion 22b. However, the inner main pump electrode 22 is not limited thereto. For example, the inner main pump electrode 22 may be formed only on the ceiling surface of the first internal cavity 20. Alternatively, the inner main pump electrode 22 may be formed only on the bottom surface of the first internal cavity 20. For example, when the inner main pump electrode 22 has the ceiling electrode portion 22a and the bottom electrode portion 22b, the ceiling electrode portion 22a and the bottom electrode portion 22b may be the same in size, or the size of the ceiling electrode portion 22a and the bottom electrode portion 22b may be different from each other. The same is true for the first measurement electrode 51. Further, the second measurement electrode 44 is formed on the bottom surface of the third internal cavity 61. However, the second measurement electrode 44 is not limited thereto. The second measurement electrode 44 may be formed on the ceiling surface of the third internal cavity 61. Alternatively, the second measurement electrode 44 may be in a tunnel-like structure similar to the inner main pump electrode 22.

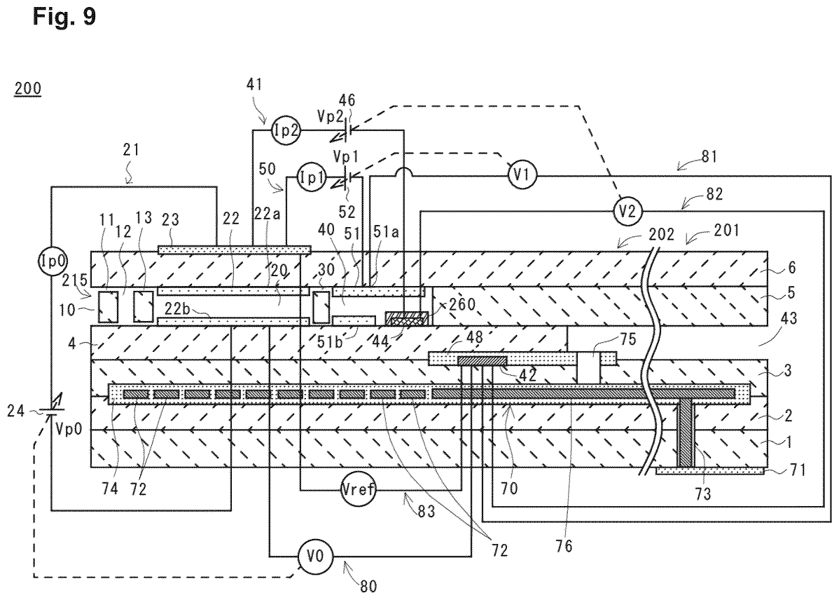

As shown in FIG. 1, in the gas sensor 100 of the above-described embodiment, the sensor element 101 has a structure in which the first measurement electrode 51 is disposed in the second internal cavity 40, and the second measurement electrode 44 is disposed in the third internal cavity 61. However, the structure of the sensor element is not limited thereto. For example, the sensor element may have a structure in which the third internal cavity 61 is not provided, and the first measurement electrode 51 and the second measurement electrode 44 are disposed in the second internal cavity 40 as shown in FIG. 9. FIG. 9 is a vertical sectional schematic view in the longitudinal direction, showing one example of a schematic configuration of a gas sensor 200 including a sensor element 201. In FIG. 9, the same member as in FIG. 1 is denoted by the same sign.

In the sensor element 201, a second internal cavity 40 of a measurement-object gas flow cavity 215 is formed to extend further to the rear end side in the longitudinal direction of the sensor element than a second internal cavity 40 in the sensor element 101. The second measurement electrode 44 is disposed at a position opposite to the second diffusion-rate limiting path 30 with respect to the first measurement electrode 51, schematically, at a position farther from the second diffusion-rate limiting path 30 than the first measurement electrode 51, in the second internal cavity 40. The second measurement electrode 44 is disposed on the upper surface of the first solid electrolyte layer 4 in the second internal cavity 40. The second measurement electrode 44 is covered with a third diffusion-rate limiting layer 260 that functions as a diffusion-rate limiting part. The third diffusion-rate limiting layer 260 is a porous alumina layer, which is a part that creates a predetermined diffusion resistance to the measurement-object gas expected to come into contact with the second measurement electrode 44 in the second internal cavity 40. The third diffusion-rate limiting layer 260 also functions as an electrode protecting layer that protects the second measurement electrode 44 from, for example, particle adhesion. The porous third diffusion-rate limiting layer 260 serves a similar role as the third diffusion-rate limiting path 60 in the sensor element 101. Therefore, a carbon dioxide concentration, a water vapor concentration and an oxygen concentration in a measurement-object gas in an objective space can be measured in the same manner as in the case of the gas sensor 100 of the above-described embodiment.

In the gas sensor 100 of the above-described embodiment, the outer pump electrode 23 has three functions as an extracavity oxygen pump electrode in the oxygen pump cell (namely, the main pump cell 21), an extracavity first measurement electrode in the first measurement pump cell 50, and an extracavity second measurement electrode in the second measurement pump cell 41. However, the outer pump electrode 23 is not limited thereto. For example, the extracavity oxygen pump electrode, the extracavity first measurement electrode, and the extracavity second measurement electrode may be formed as different electrodes. For example, any one or more of the extracavity oxygen pump electrode, the extracavity first measurement electrode, and the extracavity second measurement electrode may be provided on the outer surface of the base part 102 separately from the outer pump electrode 23 so as to be in contact with a measurement-object gas. Alternatively, the reference electrode 42 may also serve as any one or more of the extracavity oxygen pump electrode, the extracavity first measurement electrode, and the extracavity second measurement electrode.

### Method for Producing Gas Sensor

Next, one example of a method for producing the gas sensor as described above is described. A plurality of unfired sheet moldings (so-called green sheets) containing an oxygen-ion-conductive solid electrolyte such as zirconia (ZrO₂) as a ceramic component are subjected to a predetermined processing and printing of circuit pattern, and then the plurality of sheets are laminated, and the laminate was cut, and then fired. Thus the sensor element 101 can be manufactured. Then, the manufactured sensor element may be incorporated into the gas sensor.

Hereinafter, description is made while taking the case of manufacturing the sensor element 101 composed of six layers shown in FIG. 1 as an example.

First, six green sheets containing an oxygen-ion-conductive solid electrolyte such as zirconia (ZrO₂) as a ceramic component are prepared. For manufacturing of the green sheets, a known molding method can be used. The six green sheets may all have the same thickness, or the thickness differs depending on the layer to be formed. In each of the six green sheets, sheet holes or the like for use in positioning at the time of printing or stacking are formed in advance by a known method such as a punching process with a punching apparatus to prepare a blank sheet. In the blank sheet for use as the spacer layer 5, penetrating parts such as internal cavities are also formed in the same manner. Also in the remaining layers, necessary penetrating parts are formed in advance.

The blank sheets for use as six layers, namely, the first substrate layer 1, the second substrate layer 2, the third substrate layer 3, the first solid electrolyte layer 4, the spacer layer 5, and the second solid electrolyte layer 6 are subjected to printing of various patterns required for respective layers and drying treatment. For printing of a pattern, a known screen printing technique can be used. Also as the drying treatment, a known drying means can be used.

After completing the printing and drying of diverse patterns for each of the six blank sheets by repeating these steps, contact bonding treatment of stacking the six printed blank sheets in a predetermined order while positioning with the sheet holes and the like, and contact bonding at a predetermined temperature and pressure condition to give a laminate is conducted. The contact bonding treatment is conducted by heating and pressurizing with a known laminator such as a hydraulic press. While the temperature, the pressure and the time of heating and pressurizing depend on the laminator being used, they may be appropriately determined to achieve excellent lamination.

The obtained laminate includes a plurality of sensor elements 101. The laminate is cut into units of the sensor element 101. The cut laminate is fired at a predetermined firing temperature to obtain the sensor element 101. That is, the sensor element 101 is obtained by integral firing of the solid electrolyte layers and the electrodes. The firing temperature may be such a temperature that the solid electrolyte forming the base part 102 of the sensor element 101 is sintered to become a dense product, and an electrode or the like maintains desired porosity. The firing is conducted, for example, at a firing temperature of about 1200° C. or more and 1500° C. or less.

The obtained sensor element 101 is incorporated into the gas sensor 100 in such a form that the front end part of the sensor element 101 comes into contact with the measurement-object gas, and the rear end part of the sensor element 101 comes into contact with the reference gas.

### EXAMPLES

Hereinafter, the description is further made using Examples. The present invention is not limited to the following Examples.

As Examples 1 to 2 and Comparative Example 1, the gas sensors 100 shown in FIG. 1 were produced in accordance with the above-described production method of the sensor element 101. In all of Examples 1 to 2 and Comparative Example 1, the configuration of the sensor element 101 and the above control performed by the pump control part 92 were the same. The concentration calculating processing was to follow the flowchart shown in FIG. 8. In each of Examples 1 to 2 and Comparative Example 1, the following conversion formulas were used.

### Example 1

The conversion formulas considering the interference of water vapor and oxygen in Ip2, namely, the above Equations (4) to (6), were used. It is to be noted that the interference of carbon dioxide and oxygen in Ip1, and the interference of oxygen in Ip0 were also considered.

$$Ip 0 = ( aX + bY ) * ( 1 + dZ ) + cZ \qquad ( 4 )$$

$$Ip 1 = ( eX + fY ) * ( 1 + gZ ) \qquad ( 5 )$$

$$Ip 2 = ( hX ) * ( i + jY ) * ( 1 + kZ ) \qquad ( 6 )$$

### Example 2

The conversion formulas considering the interference of water vapor in Ip2 were used. It is to be noted that the interference of carbon dioxide in Ip1 was also considered.

$$Ip 0 = ( aX + bY ) + cZ \qquad ( 7 )$$

$$Ip 1 = ( eX + fY ) \qquad ( 8 )$$

$$Ip 2 = ( hX ) * ( i + jY ) \qquad ( 9 )$$

### Comparative Example 1

The conversion formulas without considering the interference of carbon dioxide, water vapor and oxygen in Ip2, namely, the above Equations (1) to (3), were used.

$$Ip 0 = ( aX + bY + cZ ) \qquad ( 1 )$$

$$Ip 1 = ( fY ) \qquad ( 2 )$$

$$Ip 2 = ( hX ) \qquad ( 3 )$$

Each of the gas sensors 100 of Examples 1 to 2 and Comparative Example 1 was attached to an exhaust pipe of a test vehicle, and driven. That is, the sensor element 101 of the gas sensor 100 was heated by the heater 72 to maintain at a driving temperature, and the pump control part 92 performed the above-described pump control. In the state where the gas sensor 100 was driven, CO₂ concentration in an exhaust gas was measured when the test vehicle was driven in the WLTC mode. That is, in accordance with the flowchart shown in FIG. 8, the concentration calculating part 93 executed the numerical analysis using the pump currents Ip0, Ip1 and Ip2 acquired at each time point and the above-described conversion formulas to calculate the CO₂ concentration. CO₂ emissions were calculated from the calculated CO₂ concentration and a MAF flow rate, by multiplying the CO₂ concentration by the MAF flow rate and the density correction. Accumulated CO₂ emissions were calculated by sequentially accumulating the CO₂ emissions calculated at each time point. The accumulated CO₂ emissions were an integrated value. The MAF flow rate was a measured valued of a MAF (Mass Air Flow) sensor installed on the vehicle, and the density correction was performed by multiplying by a correction value obtained from a ratio of atmospheric density (1.293 kg/m³) and CO₂ density (1.964 g/L), under the assumption that the exhaust density was equal to the atmospheric density (1.293 kg/m³).

Additionally, to serve as the reference for the accumulated CO₂ emissions, CO₂ concentration in the exhaust gas was measured by using an analyzer. As the analyzer, Non-Dispersive Infrared Absorption (NDIR) analyzer (Model: MEXA-ONE-D1; manufactured by HORIBA) was used. Using the CO₂ concentration measured by the analyzer, the accumulated CO₂ emissions were calculated in the same manner as described above.

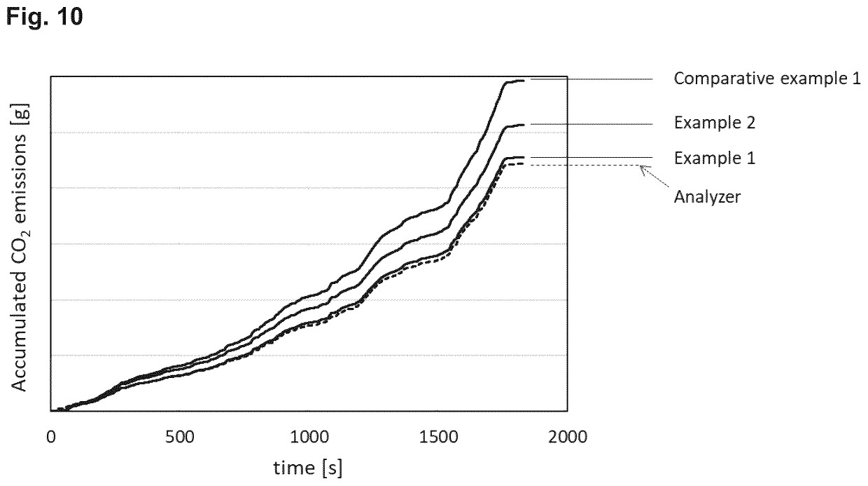

FIG. 10 shows the measurement results of the accumulated CO₂ emissions in the WLTC mode. The horizontal axis of the graph represents time [seconds; s], and the vertical axis of the graph represents the accumulated CO₂ emissions [g]. In FIG. 10, the accumulated CO₂ emissions obtained using the analyzer as the CO₂ concentration is shown with a dotted line, and the accumulated CO₂ emissions obtained using each of the gas sensors 100 of Examples 1 to 2 and Comparative Example 1 is shown with a solid line. As shown in FIG. 10, it was confirmed that both Examples 1 and 2 had a smaller difference from the case of the analyzer (the dotted line) as the reference compared with Comparative Example 1.

Regarding the accumulated CO₂ emissions in the entire WLTC mode (that is, the accumulated CO₂ emissions at the end point of the WLTC mode), a difference [%] from a reference value with the accumulated CO₂ emissions obtained using the analyzer as reference accumulated CO₂ emissions. The smaller the difference is, the higher the measurement accuracy is considered to be.
Difference [%]=[accumulated CO₂ emissions/reference accumulated CO₂ emissions−1]×100

The differences of the accumulated CO₂ emissions from the reference value in Examples 1 to 2 and Comparative Example 1 were +2.8% (Example 1), +15.6% (Example 2), and +33.6% (Comparative Example 1), respectively. As such, it was confirmed to be possible to accurately measure the carbon dioxide concentration and the water vapor concentration, by executing the numerical analysis using the conversion formulas considering at least the interference of water vapor in Ip2 and the interference (or sensitivity) of carbon dioxide in Ip1. It was also confirmed to be possible to more accurately measure the carbon dioxide concentration and the water vapor concentration, by further considering the interference of oxygen in each of the pump currents Ip0, Ip1, and Ip2.

As described above, according to the present invention, since the numerical analysis is performed treating each of the pump current Ip0, Ip1, and Ip2 as the function of two or more gas species among carbon dioxide, water vapor, and oxygen, it is possible to provide a gas sensor that can accurately measure a carbon dioxide concentration and a water vapor concentration in a measurement-object gas, even when carbon dioxide, water vapor, and oxygen coexist in arbitrary concentrations in the measurement-object gas. In other words, it is possible to provide a gas sensor that can accurately measure the carbon dioxide concentration and the water vapor concentration in the measurement-object gas regardless of gas composition in the measurement-object gas.

### EXPLANATION OF REFERENCE SIGNS IN THE DRAWINGS

1: first substrate layer; 2: second substrate layer; 3: third substrate layer; 4: first solid electrolyte layer; 5: spacer layer; 6: second solid electrolyte layer; 10: gas inlet; 11: first diffusion-rate limiting path; 12: buffer space; 13: auxiliary diffusion-rate limiting path; 15, 215: measurement-object gas flow cavity; 20: first internal cavity; 21: main pump cell; 22: inner main pump electrode; 22a: ceiling electrode portion (of the inner main pump electrode); 22b: bottom electrode portion (of the inner main pump electrode); 23: outer pump electrode; 24: variable power supply (of the main pump cell); 30: second diffusion-rate limiting path; 40: second internal cavity; 41: second measurement pump cell; 42: reference electrode; 43: reference gas introduction space; 44: second measurement electrode; 46: variable power supply (of the second measurement pump cell); 48: air introduction layer; 50: first measurement pump cell; 51: first measurement electrode; 51a: ceiling electrode portion (of the first measurement pump cell); 51b: bottom electrode portion (of the first measurement pump cell); 52: variable power supply (of the first measurement pump cell); 60: third diffusion-rate limiting path; 61: third internal cavity; 70: heater part; 71: heater electrode; 72: heater; 73: through hole; 74: heater insulating layer; 75: pressure relief vent; 76: heater lead; 80: oxygen-partial-pressure detection sensor cell for main pump control; 81: oxygen-partial-pressure detection sensor cell for first measurement pump control; 82: oxygen-partial-pressure detection sensor cell for second measurement pump control; 83: sensor cell; 90: control unit; 91: control part; 92: pump control part; 93: concentration calculating part; 100, 200: gas sensor; 101, 201: sensor element; and 102, 202: base part.

What is claimed is:

1. A gas sensor for detecting carbon dioxide and water vapor in a measurement-object gas, the gas sensor comprising a sensor element and a control unit for controlling the sensor element, wherein
the sensor element comprises:
a base part in an elongated plate shape, including an oxygen-ion-conductive solid electrolyte layer;
a measurement-object gas flow cavity having a gas inlet that opens on a surface of the base part, a first internal cavity that communicates with the gas inlet via a first diffusion-rate limiting path, and a second internal cavity that communicates with the first internal cavity via a second diffusion-rate limiting path;
an oxygen pump cell including an intracavity oxygen pump electrode disposed in the first internal cavity of the measurement-object gas flow cavity, and an extracavity oxygen pump electrode disposed at a position different from the measurement-object gas flow cavity on the base part and corresponding to the intracavity oxygen pump electrode;
a first measurement pump cell including an intracavity first measurement electrode disposed in the second internal cavity of the measurement-object gas flow cavity, and an extracavity first measurement electrode disposed at a position different from the measurement-object gas flow cavity on the base part and corresponding to the intracavity first measurement electrode; and
a second measurement pump cell including: an intracavity second measurement electrode disposed at a position opposite to the second diffusion-rate limiting path with respect to the intracavity first measurement electrode in the second internal cavity, or in a third internal cavity that communicates with the second internal cavity via a third diffusion-rate limiting path of the measurement-object gas flow cavity; and an extracavity second measurement electrode disposed at a position different from the measurement-object gas flow cavity on the base part and corresponding to the intracavity second measurement electrode;
the control unit comprises:
a pump control part for controlling operation of the oxygen pump cell, the first measurement pump cell and the second measurement pump cell, and
a concentration calculating part for calculating a concentration of each of carbon dioxide and water vapor in a measurement-object gas, wherein
the pump control part applies a predetermined oxygen pump voltage between the intracavity oxygen pump electrode and the extracavity oxygen pump electrode of the oxygen pump cell to pump out oxygen from the first internal cavity and decompose the water vapor and the carbon dioxide in the measurement-object gas in the first internal cavity,
the pump control part applies a predetermined first measurement pump voltage between the intracavity first measurement electrode and the extracavity first measurement electrode of the first measurement pump cell to pump oxygen into the second internal cavity and selectively oxidize, in the second internal cavity, hydrogen generated by decomposition of the water vapor, and
the pump control part applies a predetermined second measurement pump voltage between the intracavity second measurement electrode and the extracavity second measurement electrode of the second measurement pump cell to pump oxygen into near a surface of the intracavity second measurement electrode and selectively oxidize, near the surface of the intracavity second measurement electrode, carbon monoxide generated by decomposition of the carbon dioxide; and
the concentration calculating part calculates a carbon dioxide concentration and a water vapor concentration in the measurement-object gas by:
considering an oxygen pump current flowing through the oxygen pump cell as a function of the carbon dioxide concentration, the water vapor concentration and an oxygen concentration in the measurement-object gas,
considering a first measurement pump current flowing through the first measurement pump cell as a function of the water vapor concentration in the measurement-object gas, and the carbon dioxide concentration and/or the oxygen concentration in the measurement-object gas, and
considering a second measurement pump current flowing through the second measurement pump cell as a function of the carbon dioxide concentration in the measurement-object gas, and the water vapor concentration and/or the oxygen concentration in the measurement-object gas.

2. The gas sensor according to claim 1, wherein
the concentration calculating part previously stores:
a conversion formula for the oxygen pump current expressing the oxygen pump current as the function of the carbon dioxide concentration, the water vapor concentration and the oxygen concentration in the measurement-object gas,
a conversion formula for the first measurement pump current expressing the first measurement pump current as the function of the water vapor concentration in the measurement-object gas, and the carbon dioxide concentration and/or the oxygen concentration in the measurement-object gas, and
a conversion formula for the second measurement pump current expressing the second measurement pump current as the function of the carbon dioxide concentration in the measurement-object gas, and the water vapor concentration and/or the oxygen concentration in the measurement-object gas; and
the concentration calculating part substitutes a value of the oxygen pump current flowing through the oxygen pump cell into the conversion formula for the oxygen pump current, substitutes a value of the first measurement pump current flowing through the first measurement pump cell into the conversion formula for the first measurement pump current, and substitutes a value of the second measurement pump current flowing through the second measurement pump cell into the conversion formula for the second measurement pump current, and
the concentration calculating part executes numerical analysis of the substituted conversion formula for the oxygen pump current, conversion formula for the first measurement pump current, and conversion formula for the second measurement pump current to calculate the carbon dioxide concentration and the water vapor concentration.

3. The gas sensor according to claim 2, wherein the numerical analysis is executed by using a method selected from the group consisting of Newton method, a bisection method, Jacobi method, a secant method, and a stable method.

4. The gas sensor according to claim 2, wherein the conversion formula for the second measurement pump current is a formula in which a term regarding the carbon dioxide concentration is multiplied by a term regarding the water vapor concentration and/or a term regarding the oxygen concentration.

5. The gas sensor according to claim 2, wherein the conversion formula for the first measurement pump current is a formula in which a term regarding the water vapor concentration is added to a term regarding the carbon dioxide concentration, and/or multiplied by a term regarding the oxygen concentration.

6. The gas sensor according to claim 2, wherein the conversion formula for the oxygen pump current is a formula in which a term regarding the carbon dioxide concentration, a term regarding the water vapor concentration and a term regarding the oxygen concentration are added together.

7. The gas sensor according to claim 6, wherein the conversion formula for the oxygen pump current is a formula in which the term regarding the carbon dioxide concentration, and the term regarding the water vapor concentration are multiplied by a second term regarding the oxygen concentration.

8. The gas sensor according to claim 1, wherein the concentration calculating part calculates further the oxygen concentration in the measurement-object gas, in addition to the carbon dioxide concentration and the water vapor concentration in the measurement-object gas.

9. The gas sensor according to claim 1, wherein
the sensor element further comprises:
a reference gas chamber formed inside the base part, and being separated from the measurement-object gas flow cavity, and
a reference electrode disposed in the reference gas chamber, and
the pump control part applies the predetermined oxygen pump voltage between the intracavity oxygen pump electrode and the extracavity oxygen pump electrode of the oxygen pump cell based on a voltage between the intracavity oxygen pump electrode and the reference electrode to pump out oxygen from the first internal cavity and decompose the water vapor and the carbon dioxide in the measurement-object gas in the first internal cavity,
the pump control part applies the predetermined first measurement pump voltage between the intracavity first measurement electrode and the extracavity first measurement electrode of the first measurement pump cell based on a voltage between the intracavity first measurement electrode and the reference electrode to pump oxygen into the second internal cavity and selectively oxidize, in the second internal cavity, the hydrogen generated by the decomposition of the water vapor, and
the pump control part applies the predetermined second measurement pump voltage between the intracavity second measurement electrode and the extracavity second measurement electrode of the second measurement pump cell based on a voltage between the intracavity second measurement electrode and the reference electrode to pump oxygen into near the surface of the intracavity second measurement electrode and selectively oxidize, near the surface of the intracavity second measurement electrode, the carbon monoxide generated by the decomposition of the carbon dioxide.

10. A control method of a gas sensor for detecting carbon dioxide and water vapor in a measurement-object gas, the gas sensor being the gas sensor according to claim 1, and
the control method comprising:
a concentration calculation step of calculating a carbon dioxide concentration and a water vapor concentration in the measurement-object gas by:
considering an oxygen pump current flowing through the oxygen pump cell as a function of the carbon dioxide concentration, the water vapor concentration and an oxygen concentration in the measurement-object gas,
considering a first measurement pump current flowing through the first measurement pump cell as a function of the water vapor concentration in the measurement-object gas, and the carbon dioxide concentration and/or the oxygen concentration in the measurement-object gas,
considering a second measurement pump current flowing through the second measurement pump cell as a function of the carbon dioxide concentration in the measurement-object gas, and the water vapor concentration and/or the oxygen concentration in the measurement-object gas.
